(19) United States
(12) Patent Application Publication
(10) Pub. No.: US 2026/0262046 A1
(43) Pub. Date: Sep. 3, 2026

(54) SIGNALING ENHANCEMENTS FOR MIXED DOWNLINK TRANSMISSIONS

(71) Applicant: LENOVO (SINGAPORE) PTE. LTD, Singapore (SG)

(72) Inventors: Ahmed Hindy, Aurora, IL (US); Vijay Nangia, Woodridge, IL (US)

(73) Assignee: Lenovo (Singapore) Pte. Limited, Singapore (SG)

(21) Appl. No.: 19/159,566

(22) PCT Filed: Feb. 20, 2024
(86) PCT No.: PCT/IB2024/051620

§ 371 Date: Aug. 25, 2025

Related U.S. Application Data
(60) Provisional application No. 63/488,241, filed on Mar. 3, 2023.

(51) Int. Cl. H04W 72/23; H04B 7/06; H04L 27/26

(52) U.S. Cl. CPC H04W 72/23; H04B 7/0626; H04L 27/261

(57) ABSTRACT

Various aspects of the present disclosure relate to an apparatus for signal enhancements for mixed downlink transmissions. The apparatus, such as a network entity (e.g., a gNB, a UE) receives a first signaling as a physical downlink shared channel (PDSCH) configuration. The apparatus receives a second signaling as a downlink control information (DCI) for scheduling communication of two transport blocks (TBs) to the apparatus over a PDSCH. The two TBs are associated with different threshold transport block (TB) error probabilities. The apparatus receives over the PDSCH, based at least in part on the DCI and the PDSCH configuration, a first set of PDSCH data layers indicating a first codeword for a first TB of the two TBs and a second set of PDSCH data layers indicating a second codeword for a second TB of the two TBs.

### RELATED APPLICATION

This application claims priority to U.S. Provisional Application Ser. No. 63/488,241 filed Mar. 3, 2023 entitled “Signaling Enhancements for Mixed Downlink Transmissions,” the disclosure of which is incorporated by reference herein in its entirety.

### TECHNICAL FIELD

The present disclosure relates to wireless communications, and more specifically to mixed downlink transmissions.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Transmission of downlink data associated with different use case categories (e.g., enhanced mobile broadband (eMBB) communications, ultra reliable low latency communications (URLLC) is possible by using separate codewords triggered via different downlink control information (DCI) triggers for scheduling transmission of the codewords over a physical downlink shared channel (PDSCH). Due to increased wireless communication-based data transmissions associated with a variety of applications and use cases as well as the diverse capabilities of individual UEs served by a network, an overhead of transmitting separate DCI messages to schedule communication of different types of data blocks (e.g., eMBB-based and URLLC-based) or transport blocks (TBs) to a UE can have a notable impact on network resources and congestion.

### SUMMARY

The present disclosure relates to methods, apparatuses, and systems that support signaling enhancements for mixed downlink transmission. By utilizing the described techniques, downlink data transmission scheduling overhead and computational complexity is reduced, which reduces network congestion and conserves network resources (e.g., bandwidth). Aspects of the disclosure include techniques directed to simultaneous scheduling of different types of data transmissions (e.g., eMBB-based and URLLC-based) transmitted from a network. The described techniques are also directed to using one DCI to schedule communication of PDSCH data corresponding to two transport blocks carrying two codeword transmissions (e.g., an eMBB-based codeword and a URLLC-based codeword). The described techniques are also directed to a codeword-to-layer mapping where PDSCH layers from one or more network nodes are mapped to the two codewords. The described techniques are also directed to a transmission configuration indicator (TCI) state indication for PDSCH-based demodulation reference signal (DMRS) ports and channel state information reference signal (CSI-RS) resources corresponding to the one or more network nodes.

In some implementations of the method and apparatuses described herein, a UE receives, from at least one network entity (NE), a first signaling as a PDSCH configuration. The UE receives, from the at least one network entity, a second signaling as a DCI for scheduling communication of two TBs to the apparatus over a PDSCH. The two TBs associated with different threshold transport block (TB) error probabilities. The UE receives over the PDSCH from the at least one network entity, based at least in part on the DCI and the PDSCH configuration, a first set of PDSCH data layers indicating a first codeword for a first TB of the two TBs and a second set of PDSCH data layers indicating a second codeword for a second TB of the two TBs.

Some implementations of the method and apparatuses described herein may further include at least one of the first signaling or the second signaling includes TCI state information. The TCI state information indicating a mapping of a downlink reference signal with a set of DMRS ports. Each of the DMRS ports associated with a different PDSCH data layer. The set of DMRS ports includes a first group of DMRS ports associated with the first codeword and a second group of DMRS ports associated with the second codeword. The first group of DMRS ports is associated with a first code division multiplexing (CDM) group. The second group of DMRS ports is associated with a second CDM group different than the first CDM group. A number of the DMRS ports in the first group of DMRS ports is equal to a number of the PDSCH data layers in the first set of PDSCH data layers. A number of the DMRS ports in the second group of DMRS ports is equal to a number of the PDSCH data layers in the second set of PDSCH data layers. The downlink reference signal includes a non-zero power (NZP) CSI-RS resource for channel measurement. The NZP CSI-RS resource includes a first group of CSI-RS ports and a second group of CSI-RS ports. The first group of DMRS ports is quasi-co-located with the first group of CSI-RS ports. The second group of DMRS ports is quasi-co-located with the second group of CSI-RS ports. The first group of DMRS ports is quasi-co-located with the first group of CSI-RS ports. The second group of DMRS ports is quasi-co-located with the first group of CSI-RS ports and the second group of CSI-RS ports. The downlink reference signal comprises a first NZP CSI-RS resource and a second NZP CSI-RS resource for channel measurement. The first group of DMRS ports is quasi-co-located with the first NZP CSI-RS resource. The second group of DMRS ports is quasi-co-located with the first NZP CSI-RS resource and the second NZP CSI-RS resource. The first NZP CSI-RS resource includes a first group of CSI-RS ports and a second group of CSI-RS ports. The first group of DMRS ports is quasi-co-located with the first group of CSI-RS ports. The second group of DMRS ports is quasi-co-located with the second group of CSI-RS ports and the second NZP CSI-RS resource.

Additionally, a number of layers in the first set of PDSCH data layers of the first TB is less than or equal to four layers. A number of layers in the second set of PDSCH data layers of the second TB is less than or equal to two layers. Values of indices associated with the second set of PDSCH data layers are smaller than values of indices associated with the first set of PDSCH data layers. The first signaling includes at least one of: an indication that the apparatus is scheduled to receive the first codeword and the second codeword over the PDSCH, a resource allocation type parameter, a time-domain allocation type parameter, or a repetition scheme configuration. The second signaling includes an indication that the apparatus is scheduled to receive the first codeword corresponding to the first TB, and the second codeword corresponding to the second TB. The indication is provided in at least one of a field of the DCI, or a subset of a field of the DCI. The DCI has a DCI format indicating that the apparatus is scheduled to receive the two TBs associated with the different threshold TB error probabilities. The first TB is associated with a first threshold TB error probability that is higher than a second threshold TB error probability associated with the second TB. The first TB corresponds to a mobile broadband communication mode. The second TB corresponds to at least one of a high reliability communication mode or a low latency communication mode.

In some implementations of the method and apparatuses described herein, a network entity (NE) transmits a first signaling as a PDSCH configuration. The network entity transmits a second signaling as a DCI for scheduling transmission of two TBs to a UE over a PDSCH. The two TBs associated with different threshold TB error probabilities. The network entity transmits over the PDSCH, according to the DCI and the PDSCH configuration, a first set of PDSCH data layers indicating a first codeword for a first TB of the two TBs and a second set of PDSCH data layers indicating a second codeword for a second TB of the two TBs.

Some implementations of the method and apparatuses described herein may further include Some implementations of the method and apparatuses described herein may further include at least one of the first signaling or the second signaling includes TCI state information. The TCI state information indicating a mapping of a downlink reference signal with a set of DMRS ports. Each of the DMRS ports associated with a different PDSCH data layer. The set of DMRS ports includes a first group of DMRS ports associated with the first codeword and a second group of DMRS ports associated with the second codeword. The first group of DMRS ports is associated with a first CDM group. The second group of DMRS ports is associated with a second CDM group different than the first CDM group. A number of the DMRS ports in the first group of DMRS ports is equal to a number of the PDSCH data layers in the first set of PDSCH data layers. A number of the DMRS ports in the second group of DMRS ports is equal to a number of the PDSCH data layers in the second set of PDSCH data layers. The downlink reference signal includes a NZP CSI-RS resource for channel measurement. The NZP CSI-RS resource includes a first group of CSI-RS ports and a second group of CSI-RS ports. The first group of DMRS ports is quasi-co-located with the first group of CSI-RS ports. The second group of DMRS ports is quasi-co-located with the second group of CSI-RS ports. The first group of DMRS ports is quasi-co-located with the first group of CSI-RS ports. The second group of DMRS ports is quasi-co-located with the first group of CSI-RS ports and the second group of CSI-RS ports. The downlink reference signal comprises a first NZP CSI-RS resource and a second NZP CSI-RS resource for channel measurement. The first group of DMRS ports is quasi-co-located with the first NZP CSI-RS resource. The second group of DMRS ports is quasi-co-located with the first NZP CSI-RS resource and the second NZP CSI-RS resource. The first NZP CSI-RS resource includes a first group of CSI-RS ports and a second group of CSI-RS ports. The first group of DMRS ports is quasi-co-located with the first group of CSI-RS ports. The second group of DMRS ports is quasi-co-located with the second group of CSI-RS ports and the second NZP CSI-RS resource.

Additionally, a number of layers in the first set of PDSCH data layers of the first TB is less than or equal to four layers. A number of layers in the second set of PDSCH data layers of the second TB is less than or equal to two layers. Values of indices associated with the second set of PDSCH data layers are smaller than values of indices associated with the first set of PDSCH data layers. The first signaling includes at least one of: an indication that the apparatus is scheduled to receive the first codeword and the second codeword over the PDSCH, a resource allocation type parameter, a time-domain allocation type parameter, or a repetition scheme configuration. The second signaling includes an indication that the apparatus is scheduled to receive the first codeword corresponding to the first TB, and the second codeword corresponding to the second TB. The indication is provided in at least one of a field of the DCI, or a subset of a field of the DCI. The DCI has a DCI format indicating that the apparatus is scheduled to receive the two TBs associated with the different threshold TB error probabilities. The first TB is associated with a first threshold TB error probability that is higher than a second threshold TB error probability associated with the second TB. The first TB corresponds to a mobile broadband communication mode. The second TB corresponds to at least one of a high reliability communication mode or a low latency communication mode.

### BRIEF DESCRIPTION OF THE DRAWINGS

FIG. 1 illustrates an example of a wireless communications system that supports signal enhancements for mixed downlink transmissions in accordance with aspects of the present disclosure.

FIG. 2 illustrates an example of aperiodic trigger state defining a list of CSI report settings, as related to signal enhancements for mixed downlink transmissions in accordance with aspects of the present disclosure.

FIG. 3 illustrates an example of aperiodic trigger state that indicates the resource set and quasi co-located (QCL) information, as related to signal enhancements for mixed downlink transmissions in accordance with aspects of the present disclosure.

FIG. 4 illustrates an example of a RRC configuration for (a) a NZP CSI-RS resource and (b) a CSI-IM resource, as related to signal enhancements for mixed downlink transmissions in accordance with aspects of the present disclosure.

FIG. 5 illustrates an example of a partial CSI omission for physical uplink shared channel (PUSCH)-based CSI, as related to signal enhancements for mixed downlink transmissions in accordance with aspects of the present disclosure.

FIG. 6 illustrates an example of abstract syntax notation one (ASN-1) code for configuring an NZP-CSI-RS resource set, as related to signal enhancements for mixed downlink transmissions in accordance with aspects of the present disclosure.

FIG. 7 illustrates an example of TRS configuration, as related to signal enhancements for mixed downlink transmissions in accordance with aspects of the present disclosure.

FIG. 8 illustrates an example of ASN-1 code for QCL information, as related to signal enhancements for mixed downlink transmissions in accordance with aspects of the present disclosure.

FIG. 9 illustrates an example of ASN-1 code for PDSCH-Config IE, as related to signal enhancements for mixed downlink transmissions in accordance with aspects of the present disclosure.

FIG. 10 illustrates an example of ASN-1 code for DMRS-DownlinkConfig, as related to signal enhancements for mixed downlink transmissions in accordance with aspects of the present disclosure.

FIGS. 11A and 11B illustrate an example of DMRS patterns for mapping Type A with front-load DMRS, as related to signal enhancements for mixed downlink transmissions in accordance with aspects of the present disclosure.

FIG. 12 illustrates an example of a wireless communication system in which two transmission reception points (TRPs) are communicating an eMBB-based codeword and a URLLC-based codeword, as related to signal enhancements for mixed downlink transmissions in accordance with aspects of the present disclosure.

FIGS. 13 and 14 illustrate an example of a block diagram of devices that supports signal enhancements for mixed downlink transmissions in accordance with aspects of the present disclosure.

FIGS. 15 and 16 illustrate flowcharts of methods that support signal enhancements for mixed downlink transmissions in accordance with aspects of the present disclosure.

### DETAILED DESCRIPTION

A wireless communications system supports different use case categories for downlink signaling. Each use case category may have its own set of requirements. For example, eMBB communications are typically associated with relatively high connection throughput and/or network capacity requirements. As another example, URLLC communications are typically associated with relatively moderate throughput requirements, high reliability requirements, and/or low latency requirements. The system may accommodate different TB transmission requirements (e.g., throughput, reliability, latency, etc.) by configuring underlying transmit signal parameters (e.g., beamforming, resources, etc.). While supporting different TB configurations enables a variety of communication use cases and applications, signaling overhead (e.g., DCI messages) associated with scheduling and/or configuring the various TB transmissions can have a notable impact on network congestion and resource availability.

In aspects of signal enhancements for mixed downlink transmissions, this disclosure describes details for reducing signaling overhead associated with scheduling and/or configuration of downlink data transmissions, which reduces network congestion and/or resource consumption (e.g., by a network entity or network entities at network nodes in a wireless communication system). The described techniques also aim to enable concurrent scheduling of two TB transmissions (e.g., eMBB and URLLC) associated with different communication metrics over fully or partially overlapping resources, which improves network performance and network resource utility.

Aspects of the present disclosure include techniques directed to using one DCI to concurrently schedule of a PDSCH data transmission of two transport blocks carrying two codewords (e.g., an eMBB-based codeword and a URLLC-based codeword), where the two transport blocks are associated with different communication metrics (e.g., threshold error probabilities, latencies, etc.). The described techniques are also directed to using a codeword-to-layer mapping indicating PDSCH data layers from one or more network nodes that are mapped to the two codewords. The described techniques are also directed to a TCI state indication for PDSCH-based DMRS ports and CSI-RS resources corresponding to the one or more network nodes.

Aspects of the present disclosure are described in the context of a wireless communications system. Aspects of the present disclosure are further illustrated and described with reference to device diagrams and flowcharts.

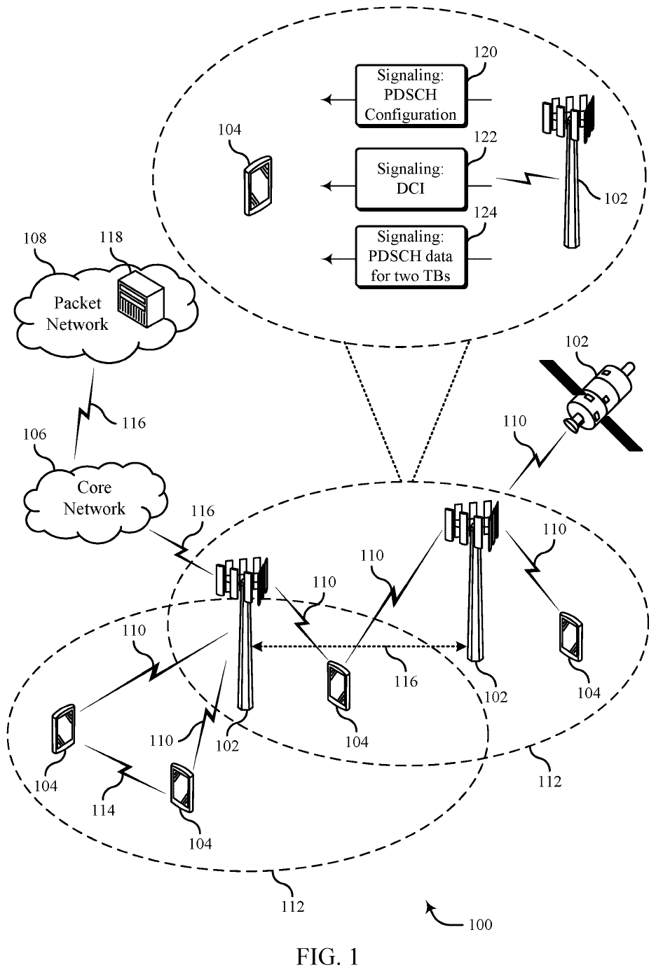

FIG. 1 illustrates an example of a wireless communications system 100 that supports signal enhancements for mixed downlink transmissions in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite (e.g., a non-terrestrial station (NTS)) associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHZ), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of signal enhancements for mixed downlink transmissions, as described herein. For instance, a network entity 102 (e.g., a base station) communicates (e.g., transmits) a first signaling 120 that includes a PDSCH configuration. The network entity 102 also communicates (e.g., transmits) a second signaling 122 as a DCI for scheduling communication of two TBs to a UE 104. In examples, the two TBs are associated with different communication modes or metrics or thresholds. For instance, a first TB is associated with a first threshold TB error probability (e.g., 0.00001) and a second TB is associated with a different second threshold TB error probability (e.g., 0.1). The UE 104 receives the first signaling 120 and the second signaling 122. The one or more network entities 102 communicate (e.g., transmits), over the PDSCH and according to the DCI and the PDSCH configuration, a first set of PDSCH data layers indicating a first codeword for the first TB and a second set of PDSCH data layers 124 indicating a second codeword for the second TB. For instance, the UE 104 receives the first and second sets of PDSCH data layers based on the DCI and the PDSCH configuration.

With reference to NR codebook types and timing for CSI reporting, new radio (5GNR) codebook types are taken into consideration, such as Type-II Codebook. With reference to NR (Rel. 15) Type-II codebook, a gNB can be equipped with a two-dimensional (2D) antenna array with N₁, N₂ antenna ports per polarization placed horizontally and vertically, and communication occurs over N₃ precoding matrix indicator (PMI) sub-bands. A PMI sub-band consists of a set of resource blocks, with each resource block consisting of a set of subcarriers. In this case, 2N₁N₂ CSI-RS ports are utilized to enable downlink channel estimation with high resolution for NR (Rel. 15) Type-II codebook. In order to reduce the uplink (UL) feedback overhead, a discrete Fourier transform (DFT)-based CSI compression of the spatial domain is applied to L dimensions per polarization, where L<N₁N₂. In the sequel, the indices of the 2L dimensions are referred as the spatial domain (SD) basis indices. The magnitude and phase values of the linear combination coefficients for each sub-band are fed back to the gNB as part of the CSI report. The 2N₁N₂×N₃ codebook per layer l takes on the form:

$${W}_{l} = {W}_{1} {W}_{2 , l} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$$\begin{matrix}{u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} \\ B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] \\ {l}_{i} = {O}_{1} {n}_{1}^{( i )} + {q}_{1} , 0 \leq {n}_{1}^{( i )} < {N}_{1} , 0 \leq {q}_{1} < {O}_{1} , \\ {m}_{i} = {O}_{2} {n}_{2}^{( i )} + {q}_{2} , 0 \leq {n}_{2}^{( i )} < {N}_{2} , 0 \leq {q}_{2} < {O}_{2}\end{matrix}$$

where the superscript ^{T} denotes a matrix transposition operation. Note that O₁, O₂ oversampling factors are assumed for the 2D DFT matrix from which matrix B is drawn. Note that W₁ is common across all layers. W_{2,l} is a 2L×N₃ matrix, where the i^{th} column corresponds to the linear combination coefficients of the 2L beams in the i^{th} sub-band. Only the indices of the L selected columns of B are reported, along with the oversampling index taking on O₁O₂ values. Note that W_{2,l} are independent for different layers.

With reference to NR (Rel. 15) Type-II Port Selection codebook, only K (where K≤2N₁N₂) beamformed CSI-RS ports are utilized in a downlink (DL) transmission, in order to reduce complexity. The K×N₃ codebook matrix per layer takes on the form:

$${W}_{l} = {W}_{1}^{PS} {W}_{2 , l} .$$

Here, W₂ follow the same structure as the conventional NR Type-II Codebook, and are layer specific.

$${W}_{1}^{PS}$$

is a K×2L block-diagonal matrix with two identical diagonal blocks, i.e.,

$${W}_{1}^{PS} = [ \begin{matrix}E & 0 \\ 0 & E\end{matrix} ] ,$$

and E is an

$$\frac{K}{2} \times L$$

matrix whose columns are standard unit vectors, as follows:

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

where

$${e}_{i}^{( K )}$$

is a standard unit vector with a 1 at the i^{th} location. Here d_{PS} is an RRC parameter which takes on the values {1, 2, 3, 4} under the condition d_{PS}≤min (K/2, L), whereas m_{PS} takes on the values

$$\{ 0 , … , ⌈ \frac{K}{2 {d}_{PS}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0, 1, . . . , 7} are as follows:

$$\begin{matrix}[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , \\ [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .\end{matrix}$$

When d_{PS}=2, the 4 possible realizations of E corresponding to m_{PS}={0,1,2,3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

With reference to NR (Rel. 15) Type-I codebook, the Type-I codebook is the baseline codebook for NR, with a variety of configurations. The most common utility of the Type-I codebook is a special case of NR Type-II codebook with L=1 for rank indicator (RI)=1,2, wherein a phase coupling value is reported for each sub-band, i.e., W_{2,l} is 2×N₃, with the first row equal to [1, 1, . . . , 1] and the second row equal to [e^{j2πØ}^{₀}, . . . , e^{j2πØ}^{_{N3-1}}]. Under specific configurations, φ₀=φ₁ . . . =φ, i.e., wideband reporting. For RI>2 different beams are used for each pair of layers. The NR Type-I codebook can be depicted as a low-resolution version of NR Type-II codebook with spatial beam selection per layer-pair and phase combining only.

With reference to NR (Rel. 16) Type-II codebook, a gNB can be equipped with a two-dimensional (2D) antenna array with N₁, N₂ antenna ports per polarization placed horizontally and vertically and communication occurs over N₃ PMI sub-bands. A PMI sub-band consists of a set of resource blocks, with each resource block consisting of a set of subcarriers. In this case, 2N₁N₂N₃ CSI-RS ports are utilized to enable DL channel estimation with high resolution for NR (Rel. 16) Type-II codebook. In order to reduce the UL feedback overhead, a DFT-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form:

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂×L matrix with columns drawn from a 2D oversampled DFT matrix, as follows:

$${u}_{m} = [ 1 {e}^{j \frac{2 π m}{{O}_{2} {N}_{2}}} … {e}^{j \frac{2 π m ( {N}_{2} - 1 )}{{O}_{2} {N}_{2}}} ] ,$$

$${v}_{l , m} = {[ {u}_{m} {e}^{j \frac{2 π l}{{O}_{2} {N}_{2}}} {u}_{m} … {e}^{j \frac{2 π l ( {N}_{1} - 1 )}{{O}_{2} {N}_{2}}} {u}_{m} ]}^{T} ,$$

$$B = [ {v}_{{l}_{0} , {m}_{0}} {v}_{{l}_{1} , {m}_{1}} … {v}_{{l}_{L - 1} , {m}_{L - 1}} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. Note that O₁, O₂ oversampling factors are assumed for the 2D DFT matrix from which matrix B is drawn. Note that W₁ is common across all layers. W_{f} is an N₃×M matrix (M<N₃) with columns selected from a critically-sampled size-N₃ DFT matrix, as follows:

$${W}_{f , l} = [ {f}_{{k}_{0}} {f}_{{k}_{1}} … {f}_{{k}_{M ′ - 1}} ] , 0 \leq {k}_{i} \leq {N}_{3} - 1 ,$$

$${f}_{k} = {[ 1 {e}^{- j \frac{2 π k}{{N}_{3}}} … {e}^{- j \frac{2 π k ( {N}_{3} - 1 )}{{N}_{3}}} ]}^{T} .$$

Only the indices of the L selected columns of B are reported, along with the oversampling index taking on O₁O₂ values. Similarly, for W_{f,1}, only the indices of the M selected columns out of the predefined size-N₃ DFT matrix are reported. In the sequel the indices of the M dimensions are referred to as the selected frequency domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, W_{f} are selected independent for different layers. Magnitude and phase values of an approximately β fraction of the 2LM available coefficients are reported to the gNB (β<1) as part of the CSI report. Coefficients with zero magnitude are indicated via a per-layer bitmap, with the strongest coefficient amplitude set to one, and an index of the strongest coefficient reported. No amplitude or phase information is explicitly reported for this coefficient. Amplitude and phase values of a maximum of [2βLM]−1 coefficients, compared with 2N₁N₂×N₃−1 coefficients of a theoretical design.

For the Type-II Port Selection codebook (Rel. 16), only K (where K≤2N₁N₂) beamformed CSI-RS ports are utilized in DL transmission, in order to reduce complexity. The K×N₃ codebook matrix per layer takes on the form:

$${W}_{l} = {W}_{1}^{PS} {\tilde{W}}_{2 , l} {W}_{f , l}^{H} .$$

Here, \tilde{W}_{2,l} and W_{f,l} follow the same structure as the conventional NR (Rel. 16) Type-II Codebook, where both are layer specific. The matrix

$${W}_{1}^{PS}$$

is a K×2L block-diagonal matrix with the same structure as that in the NR (Rel. 15) Type-II Port Selection codebook.

The NR (Rel. 17) Type-II Port Selection codebook follows a similar structure as that of Rel. 15 and Rel. 16 port-selection codebooks, as follows:

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers. Here, \tilde{W}_{2,l} and W_{f,l} follow the same structure as the conventional NR Rel. 16 Type-II Codebook, however M is limited to 1,2 only, with the network configuring a window of size N={2,4} for M=2. Moreover, the bitmap is reported unless β=1 and the UE reports all the coefficients for a rank up to a value of two.

With reference to CSI reporting, the codebook report is partitioned into two parts based on the priority of information reported. Each part is encoded separately (Part 1 has a possibly higher code rate). Below, only the parameters for NR (Rel. 16) Type-II codebook are listed. With reference to the content of a CSI report, a Part 1 is RI+channel quality indicator (CQI)+total number of coefficients. A Part 2 is SD basis indicator+FD basis indicator/layer+bitmap/layer+coefficient amplitude info/layer+coefficient phase info/layer+strongest coefficient indicator/layer. Furthermore, Part 2 CSI can be decomposed into sub-parts, each with different priority (higher priority information listed first). Such partitioning is required to allow dynamic reporting size for a codebook based on available resources in the UL phase. Additionally, Type-II codebook is based on aperiodic CSI reporting, and only reported in PUSCH via DCI triggering (one exception). Type-I codebook can be based on periodic CSI reporting (physical uplink control channel (PUCCH)) or semi-persistent CSI reporting (PUSCH or PUCCH) or aperiodic reporting (PUSCH).

With reference to reporting CSI report Part 2, note that multiple CSI reports may be transmitted with different priorities, as shown below in Table 1.

Note that the priority of the N_{Rep} CSI reports are based on the following: (1) a CSI report corresponding to one CSI reporting configuration for one cell may have higher priority compared with another CSI report corresponding to one other CSI reporting configuration for the same cell; (2) CSI reports intended to one cell may have higher priority compared with other CSI reports intended to another cell; (3) CSI reports may have higher priority based on the CSI report content (e.g., CSI reports carrying L1-reference signal received power (RSRP) information have higher priority); and (4) CSI reports may have higher priority based on their type (e.g., whether the CSI report is aperiodic, semi-persistent or periodic, and whether the report is sent via PUSCH or PUCCH, may impact the priority of the CSI report). In light of that, CSI reports may be prioritized as follows, where CSI reports with lower identifiers (IDs) have higher priority:

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

$$s : CSI reporting configuration index , and$$

$${M}_{s} : Maximum number of CSI reporting configurations$$

$$c : Cell index , and {N}_{cells} : Number of serving cells$$

$$k : 0 for CSI reports carrying L 1 - RSRP or$$

$$L 1 - Signal - to - Interference - and - Noise Ratio ( SINR ) , 1 otherwise$$

$$y : 0 for aperiodic reports , 1 for semi - persistent reports on PUSCH ,$$

$$2 for semi - persistent reports on PUCCH , 3 for periodic reports .$$

TABLE 1
Priority Reporting Levels for Part 2 CSI.

Priority 0:
For CSI reports 1 to N_{Rep}, Group 0 CSI for CSI reports
configured as ‘typeII-r16’ or ‘typeII-PortSelection-r16’; Part 2
wideband CSI for CSI reports configured otherwise
Priority 1:
Group 1 CSI for CSI report 1, if configured as ‘typeII-r16’ or
‘typeII-PortSelection-r16’; Part 2 sub-band CSI of even
sub-bands for CSI report 1, if configured otherwise
Priority 2:
Group 2 CSI for CSI report 1, if configured as ‘typeII-r16’ or
‘typeII-PortSelection-r16’; Part 2 sub-band CSI of odd
sub-bands for CSI report 1, if configured otherwise
Priority 3:
Group 1 CSI for CSI report 2, if configured as ‘typeII-r16’ or
‘typeII-PortSelection-r16’; Part 2 sub-band CSI of even
sub-bands for CSI report 2, if configured otherwise
Priority 4:
Group 2 CSI for CSI report 2, if configured as ‘typeII-r16’ or
‘typeII-PortSelection-r16’. Part 2 sub-band CSI of odd
sub-bands for CSI report 2, if configured otherwise
.
.
.
Priority 2N_{Rep} − 1:
Group 1 CSI for CSI report N_{Rep}, if configured as ‘typeII-r16’
or ‘typeII-PortSelection-r16’; Part 2 sub-band CSI of even
sub-bands for CSI report N_{Rep}, if configured otherwise
Priority 2N_{Rep}:
Group 2 CSI for CSI report N_{Rep}, if configured as ‘typeII-r16’
or ‘typeII-PortSelection-r16’; Part 2 sub-band CSI of odd
sub-bands for CSI report N_{Rep}, if configured otherwise

With reference to triggering aperiodic CSI reporting on PUSCH, a UE needs to report the needed CSI information for the network using the CSI framework in NR (Rel. 15). The triggering mechanism between a report setting and a resource setting can be summarized as shown below in Table 2.

TABLE 2
Triggering mechanism between a report setting and a resource setting.

| | | Periodic CSI | | AP CSI |
|---|---|---|---|---|
| | | reporting | SP CSI reporting | Reporting |
| Time Domain | Periodic | RRC configured | MAC CE (PUCCH) | DCI |
| Behavior of | CSI-RS | | DCI (PUSCH) | |
| Resource | SP CSI-RS | Not Supported | MAC CE (PUCCH) | DCI |
| Setting | | | DCI (PUSCH) | |
| | AP CSI-RS | Not Supported | Not Supported | DCI |

Moreover, all associated resource settings for a CSI report setting need to have the same time domain behavior. Periodic CSI-RS/interference management (IM) resource and CSI reports are assumed to be present and active once configured by radio resource control (RRC). Aperiodic and semi-persistent CSI-RS/IM resources and CSI reports are explicitly triggered or activated. For aperiodic CSI-RS/IM resources and aperiodic CSI reports, the triggering is performed jointly by transmitting a DCI format 0-1. Semi-persistent CSI-RS/IM resources and semi-persistent CSI reports are independently activated.

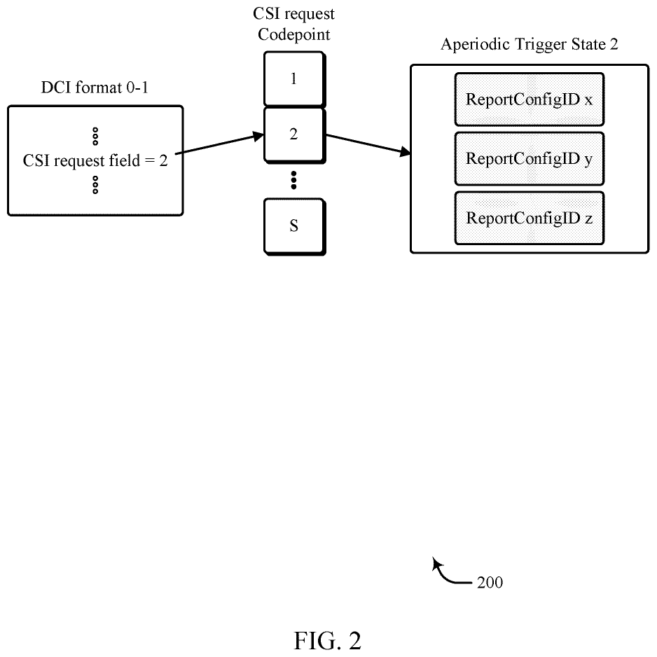

FIG. 2 illustrates an example 200 of aperiodic trigger state defining a list of CSI report settings as related to signal enhancements for mixed downlink transmissions in accordance with aspects of the present disclosure. In this example 200, for aperiodic CSI-RS/IM resources and aperiodic CSI reports, the triggering is performed jointly by transmitting a DCI format 0-1. The DCI format 0_1 contains a CSI request field (0 to 6 bits). A non-zero request field points to an aperiodic trigger state configured by RRC. An aperiodic trigger state in turn is defined as a list of up to sixteen (16) aperiodic CSI report settings, identified by a CSI report setting ID for which the UE calculates simultaneously CSI and transmits it on the scheduled PUSCH transmission.

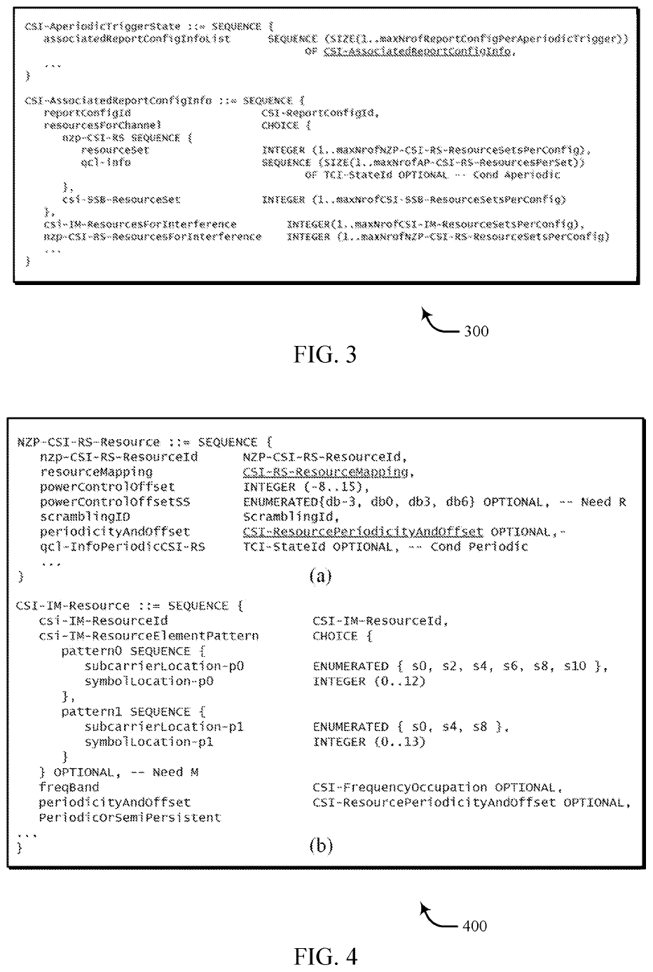

FIG. 3 illustrates an example 300 of aperiodic trigger state that indicates the resource set and QCL information as related to signal enhancements for mixed downlink transmissions in accordance with aspects of the present disclosure. This example 300 indicates that when the CSI report setting is linked with an aperiodic resource setting (which may include multiple resource sets), the aperiodic NZP CSI-RS resource set for channel measurement, the aperiodic CSI-IM resource set (if used), and the aperiodic NZP CSI-RS resource set for IM (if used) to use for a given CSI report setting are also included in the aperiodic trigger state definition, as shown in this example 300. For aperiodic NZP CSI-RS, the QCL source to use is also configured in the aperiodic trigger state. The UE assumes that the resources used for the computation of the channel and interference can be processed with the same spatial filter (i.e. quasi-co-located with respect to “QCL-TypeD”).

FIG. 4 illustrates an example 400 of a RRC configuration for (a) an NZP-CSI-RS resource and (b) CSI-IM resource as related to signal enhancements for mixed downlink transmissions in accordance with aspects of the present disclosure. This example 400 indicates the RRC configuration for NZP-CSI-RS/CSI-IM resources. A Table 3 below summarizes the type of UL channels used for CSI reporting as a function of the CSI codebook type.

TABLE 3
UL channels used for CSI reporting as
a function of the CSI codebook type.

| | Periodic CSI | | AP CSI |
|---|---|---|---|
| | reporting | SP CSI reporting | reporting |
| Type I WB | PUCCH Format | PUCCH Format 2 | PUSCH |
| | 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II | | PUCCH Format 3, 4 | |
| Part 1 only | | | |

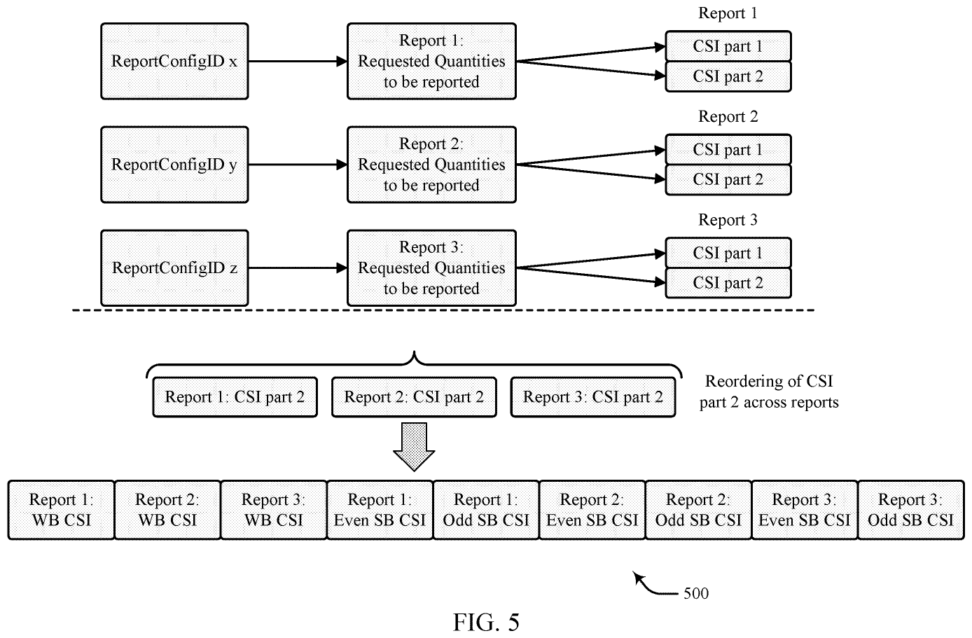

FIG. 5 illustrates an example 500 of a partial CSI omission for PUSCH-based CSI as related to signal enhancements for mixed downlink transmissions in accordance with aspects of the present disclosure. For aperiodic CSI reporting, PUSCH-based reports are divided into two CSI parts, CSI Part1 and CSI Part 2, because the size of CSI payload varies significantly, and therefore a worst-case uplink control information (UCI) payload size design would result in large overhead. CSI Part 1 has a fixed payload size (and can be decoded by the gNB without prior information) and contains the following: RI (if reported), CSI-RS resource index (CRI) (if reported), and CQI for the first codeword; and a number of non-zero wideband amplitude coefficients per layer for Type II CSI feedback on PUSCH. CSI Part 2 has a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 will be ordered as indicated in this example 500.

As described, CSI reports are prioritized according to several factors, including the time-domain behavior and physical channel, where more dynamic reports are given precedence over less dynamic reports and PUSCH has precedence over PUCCH; CSI content, where beam reports (i.e. L1-RSRP reporting) has priority over regular CSI reports; the serving cell to which the CSI corresponds (in case of carrier aggregation (CA) operation), and CSI corresponding to the PCell has priority over CSI corresponding to Scells; and the reportConfigID.

With reference to CQI reporting, a CSI report may include a CQI report quantity corresponding to channel quality assuming a maximum target transport block error rate, which indicates a modulation order, a code rate, and a corresponding spectral efficiency associated with the modulation order and code rate pair. Examples of the maximum transport block error rates are 0.1 and 0.00001. The modulation order can vary from quadrature phase-shift keying (QPSK) up to 1024QAM, whereas the code rate may vary from 30/1024 up to 948/1024. One example of a CQI table for a 4-bit CQI indicator that identifies a possible CQI value with the corresponding modulation order, code rate and efficiency is provided in Table 4 below.

A CQI value may be reported in two formats: a wideband format, wherein one CQI value is reported corresponding to each PDSCH transport block, and a sub-band format, where one wideband CQI value is reported for the entire transport block, in addition to a set of sub-band CQI values corresponding to CQI sub-bands on which the transport block is transmitted. CQI sub-band sizes are configurable, and depends on the number of PRBs in a bandwidth part, as shown in Table 5 below.

TABLE 4
Example of a 4-bit CQI table.

| CQI index | modulation | code rate × 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 5
Configurable sub-band sizes for a
given bandwidth part (BWP) size.

| Bandwidth part (PRBs) | Sub-band size (PRBs) |
|---|---|
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, sub-band CQI values are reported in a full form (i.e., using 4 bits for each sub-band CQI based on a CQI table, e.g., Table 4). If the higher layer parameter cqi-BitsPerSubband in CSI-ReportConfig is not configured, for each sub-band s, a 2-bit sub-band differential CQI value is reported, defined as:

$$Sub - band Offset level ( s ) = sub - band CQI index ( s ) - wideband CQI index .$$

The mapping from the 2-bit sub-band differential CQI values to the offset level is shown in Table 6 below.

TABLE 6
Mapping sub-band differential CQI value to offset level.

| Sub-band differential CQI value | Offset level |
|---|---|
| 0 | 0 |
| 1 | 1 |
| 2 | ≥2 |
| 3 | ≤−1 |

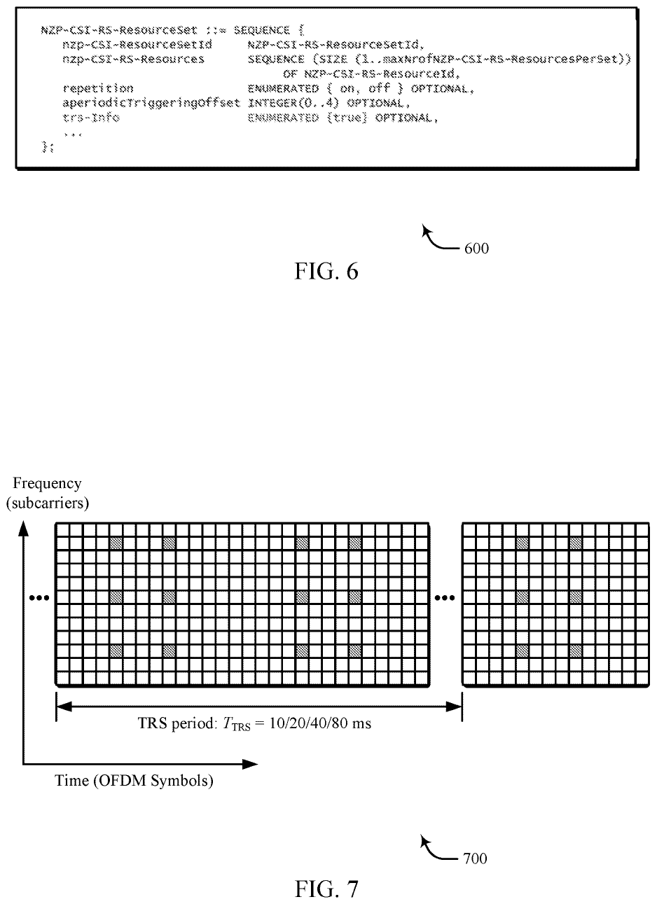

FIG. 6 illustrates an example 600 of ASN-1 code for configuring an NZP-CSI-RS resource set, as related to signal enhancements for mixed downlink transmissions in accordance with aspects of the present disclosure. Aspects of signaling enhancements for mixed downlink transmissions include and/or are directed to TRS, which is transmitted for establishing fine time and frequency synchronization at a UE to aid in demodulation of PDSCH, particularly for higher order modulations. A TRS is an NZP CSI-RS resource set with “TRS-info” set to true. As shown in the example 600, “trs-info” indicates that the antenna port for all NZP-CSI-RS resources in the CSI-RS resource set is the same. The TRS contains either 2 or 4 periodic CSI-RS resources with periodicity 2^{-μ}*Xp slots where Xp=10, 20, 40, or 80 and where μ is related to the sub carrier spacing (SCS), i.e. μ=0, 1, 2, 3, 4 for 15, 30, 60, 120, 240 kHz, respectively. The slot offsets for the 2 or 4 CSI-RS resources are configured such that the first pair of resources are transmitted in one slot, and the 2nd pair (if configured) are transmitted in the next (adjacent) slot. All four resources are single port with density 3, as further shown in FIG. 7.

FIG. 7 illustrates an example 700 of TRS configuration, as related to signal enhancements for mixed downlink transmissions in accordance with aspects of the present disclosure. In this example 700, the two CSI-RS within a slot are always separated by four symbols in the time domain. This time-domain separation sets a limit for the maximum frequency error that can be compensated. Likewise, the frequency-domain separation of four subcarriers sets a limit for the maximum timing error that can be compensated. The maximum number of TRS a UE can be configured with is a UE capability. For example, the maximum number of TRS resource sets (per component carrier (CC)) that a UE is able to track simultaneously: Candidate value set {1 to 8}. The maximum number of TRS resource sets configured to UE per CC: Candidate value set: {1 to 64}. the UE is mandated to report at least 8 for FR1 and 16 for FR2. The maximum number of TRS resource sets configured to UE across CCs: Candidate value set: {1 to 256}. UE is mandated to report at least 16 for FR1 and 32 for FR2. Furthermore, an aperiodic TRS is a set of aperiodic CSI-RS for tracking that is optionally configured, but a periodic TRS always needs to be configured, and its time and frequency domain configurations (except for the periodicity) must match those of the periodic TRS. The UE may assume that the aperiodic TRS resources are quasi-co-located with the periodic TRS resources.

FIG. 8 illustrates an example 800 of ASN-1 code for QCL information, as related to signal enhancements for mixed downlink transmissions in accordance with aspects of the present disclosure. In this example 800, a TCI state (in example 800 and as configured by RRC) will have two QCL types (i.e., two reference signals) with the second QCL type only for operation in FR2.

With reference to DMRS and reception of DMRS for PDSCH, QCL TypeA properties (Doppler shift, Doppler spread, average delay, delay spread) can be inferred from a periodic TRS. In turn for periodic TRS, QCL TypeC properties (Average delay, Doppler shift) can be inferred from a synchronization signal block (SSB). The DMRS is used to estimate channel coefficients for coherent detection of the physical channels. For downlink, the DMRS is subject to the same precoding as the PDSCH. NR first defines two time-domain structures for DMRS according to the location of the first DMRS symbol. For example, mapping Type A, where the first DMRS is located in the second and the third symbol of the slot, and the DMRS is mapped relative to the start of the slot boundary, regardless of where in the slot the actual data transmission occurs. Further, mapping Type B, where the first DMRS is positioned in the first symbol of the data allocation, that is, the DMRS location is not given relative to the slot boundary, rather relative to where the data are located.

The mapping of PDSCH transmission can be dynamically signaled as part of the DCI. Moreover, the DMRS has two types, Types 1 and 2, which are distinguished in frequency-domain mapping and the maximum number of orthogonal reference signals. Type 1 can provide up to four orthogonal signals using a single-symbol DMRS and up to eight orthogonal reference signals using a double-symbol DMRS. For four orthogonal signals, ports 1000 and 1001 use even-numbered subcarriers and are separated in the code domain within the CDM group (length-2 orthogonal sequences in the frequency domain). Antenna ports 1000 and 1001 belong to CDM group 0, since they use the same subcarriers. Similarly, ports 1002 and 1003 belong to CDM group 1 and are generated in the same way using odd-numbered subcarriers. The DMRS Type 2 has a similar structure to Type 1, but Type 2 can provide 6 and 12 patterns depending on the number of symbols. Four subcarriers are used in each resource block and in each CDM group defining three CDM groups.

FIG. 9 illustrates an example 900 of ASN-1 code for PDSCH-Config IE, as related to signal enhancements for mixed downlink transmissions in accordance with aspects of the present disclosure. In this example 900, note that the configuration of the DMRS Type is provided through higher-layer signaling independently for each PDSCH and PUSCH, each mapping Type (A or B), and each BWP independently (see the RRC configuration). The PDSCH-Config Information Element (IE), as shown in example 900, is used to configure the UE specific PDSCH parameters.

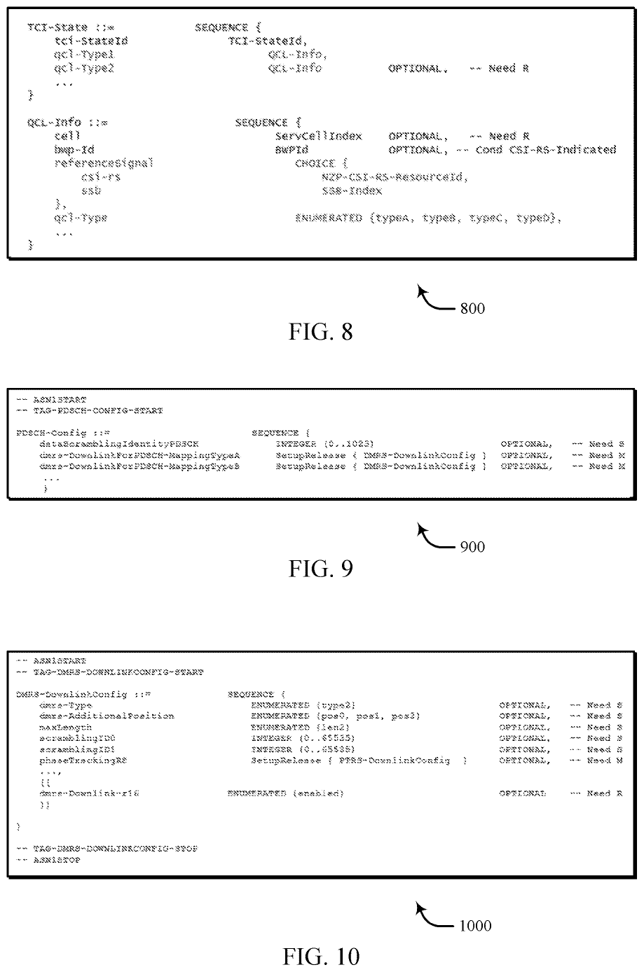

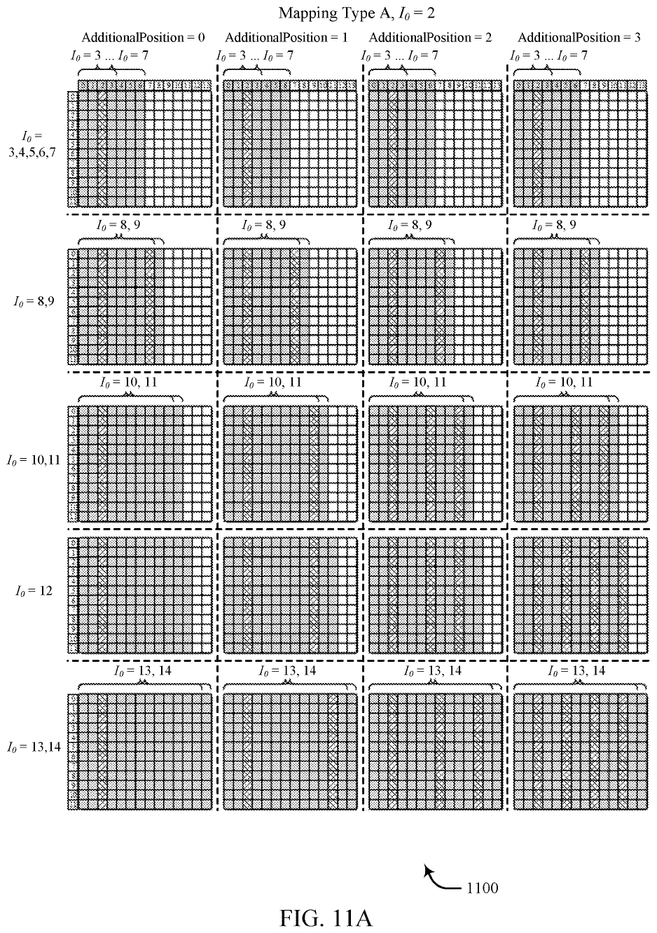

FIG. 10 illustrates an example 1000 of ASN-1 code for DMRS-DownlinkConfig, as related to signal enhancements for mixed downlink transmissions in accordance with aspects of the present disclosure. In this example 1000, the IE DMRS-DownlinkConfig is used to configure downlink demodulation reference signals for PDSCH.

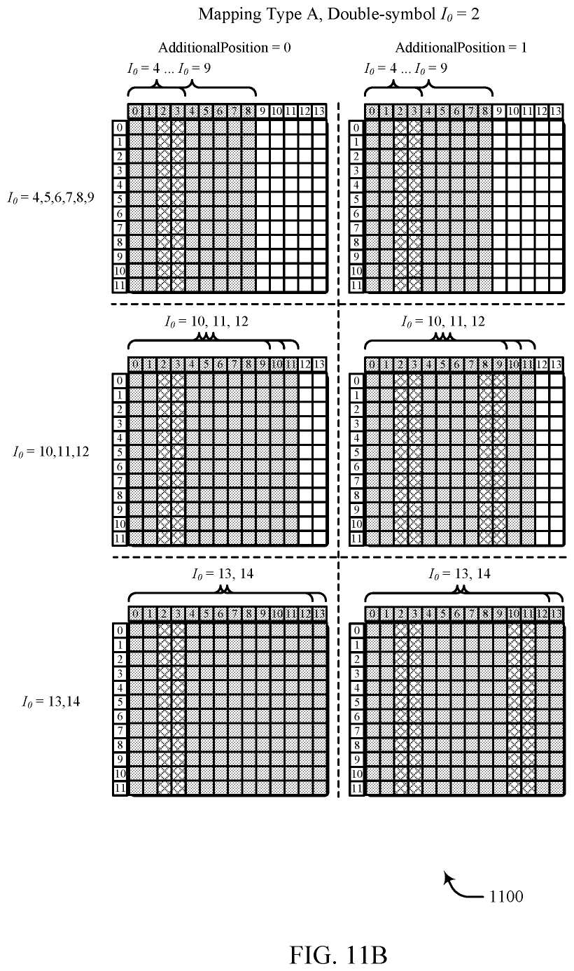

FIGS. 11A and 11B illustrate an example 1100 of DMRS patterns for mapping Type A with front-load DMRS, as related to signaling enhancements for mixed downlink transmissions in accordance with aspects of the present disclosure. In this example 1100, the time domain mapping of the DMRS patterns can be decomposed to two parts. For example, the first part defines the DMRS pattern used for the front-load DMRS, and then the second part defines a set of additional DMRS symbols inside the scheduled data channel duration which are either single-symbols, or double-symbols, depending on the length of the front-load DMRS. Inside the scheduled time-domain allocation of a PDSCH, the UE may expect up to 4 DMRS symbols. The location of the DMRS is defined by both higher-layer configuration and dynamic (DCI-based) signaling, such as dmrs-TypeA-Position, maxLength, and dmrs-AdditionalPosition. When double-symbol DMRS is used, there can be up to one more double-symbol DMRS (total 4 DMRS symbols inside the PDSCH allocation). Different DMRS patterns for mapping Type A with front-load DMRS are shown in the example 1100.

In the absence of CSI-RS configuration, and unless otherwise configured, the UE may assume PDSCH DMRS and synchronization signal (SS)/physical broadcast channel (PBCH) block antenna ports are quasi co-located with respect to Doppler shift, Doppler spread, average delay, delay spread, and spatial Rx parameters (if applicable). However, a CSI-RS for tracking can be used as a QCL reference (e.g., having larger bandwidth than an SS/PBCH block). Furthermore, the UE may assume that the PDSCH DMRS within the same CDM group are quasi co-located with respect to Doppler shift, Doppler spread, average delay, delay spread, and spatial Rx. The UE may then perform a joint estimation of DMRS ports which are CDMed using the same long-term statistics, and it is not required to measure, or use, different long-term statistics for different DMRS ports of the same PDSCH.

With reference to codeword-to-layer mapping, the UE may assume that complex-valued modulation symbols for each of the codewords to be transmitted are mapped onto one or several layers according to Table 7. Complex-valued modulation symbols

$${d}^{( q )} ( 0 ) , … , {d}^{( q )} ( {M}_{symb}^{( q )} - 1 )$$

codeword q may be mapped onto the layers

$$x ( i ) = {[ {x}^{( 0 )} ( i ) … {x}^{( υ - 1 )} ( i ) ]}^{T} , i = 0 , 1 , … , {M}_{symb}^{layer} - 1$$

where v is the number of layers and

$${M}_{symb}^{layer}$$

is the number of modulation symbols per layer.

TABLE 7
Codeword-to-layer mapping for spatial multiplexing.

| | | Codeword-to-layer mapping |
|---|---|---|
| Number of layers | Number of codewords | $i = 0 , 1 , … , {M}_{symb}^{layer} - 1$ |
| 1 | 1 | ${x}^{( 0 )} ( i ) = {d}^{( 0 )} ( i ) \qquad {M}_{symb}^{layer} = {M}_{symb}^{( 0 )}$ |
| 2 | 1 | $\begin{matrix}{x}^{( 0 )} ( i ) = {d}^{( 0 )} ( 2 i ) \\ {x}^{( 1 )} ( i ) = {d}^{( 0 )} ( 2 i + 1 )\end{matrix} {M}_{symb}^{layer} = {M}_{symb}^{( 0 )} / 2$ |
| 3 | 1 | $\begin{matrix}{x}^{( 0 )} ( i ) = {d}^{( 0 )} ( 3 i ) \\ {x}^{( 1 )} ( i ) = {d}^{( 0 )} ( 3 i + 1 ) \\ {x}^{( 2 )} ( i ) = {d}^{( 0 )} ( 3 i + 2 )\end{matrix} {M}_{symb}^{layer} = {M}_{symb}^{( 0 )} / 3$ |
| 4 | 1 | $\begin{matrix}{x}^{( 0 )} ( i ) = {d}^{( 0 )} ( 4 i ) \\ {x}^{( 1 )} ( i ) = {d}^{( 0 )} ( 4 i + 1 ) \\ {x}^{( 2 )} ( i ) = {d}^{( 0 )} ( 4 i + 2 ) \\ {x}^{( 3 )} ( i ) = {d}^{( 0 )} ( 4 i + 3 )\end{matrix} {M}_{symb}^{layer} = {M}_{symb}^{( 0 )} / 4$ |
| 5 | 2 | $\begin{matrix}{x}^{( 0 )} ( i ) = {d}^{( 0 )} ( 2 i ) \\ {x}^{( 1 )} ( i ) = {d}^{( 0 )} ( 2 i + 1 ) \\ {x}^{( 2 )} ( i ) = {d}^{( 1 )} ( 3 i ) \\ {x}^{( 3 )} ( i ) = {d}^{( 1 )} ( 3 i + 1 ) \\ {x}^{( 4 )} ( i ) = {d}^{( 1 )} ( 3 i + 2 )\end{matrix} {M}_{symb}^{layer} = {M}_{symb}^{( 0 )} / 2 = {M}_{symb}^{( 1 )} / 3$ |
| 6 | 2 | $\begin{matrix}{x}^{( 0 )} ( i ) = {d}^{( 0 )} ( 3 i ) \\ {x}^{( 1 )} ( i ) = {d}^{( 0 )} ( 3 i + 1 ) \\ {x}^{( 2 )} ( i ) = {d}^{( 0 )} ( 3 i + 2 ) \\ {x}^{( 3 )} ( i ) = {d}^{( 1 )} ( 3 i ) \\ {x}^{( 4 )} ( i ) = {d}^{( 1 )} ( 3 i + 1 ) \\ {x}^{( 5 )} ( i ) = {d}^{( 1 )} ( 3 i + 2 )\end{matrix} {M}_{symb}^{layer} = {M}_{symb}^{( 0 )} / 3 = {M}_{symb}^{( 1 )} / 3$ |
| 7 | 2 | $\begin{matrix}{x}^{( 0 )} ( i ) = {d}^{( 0 )} ( 3 i ) \\ {x}^{( 1 )} ( i ) = {d}^{( 0 )} ( 3 i + 1 ) \\ {x}^{( 2 )} ( i ) = {d}^{( 0 )} ( 3 i + 2 ) \\ {x}^{( 3 )} ( i ) = {d}^{( 1 )} ( 4 i ) \\ {x}^{( 4 )} ( i ) = {d}^{( 1 )} ( 4 i + 1 ) \\ {x}^{( 5 )} ( i ) = {d}^{( 1 )} ( 4 i + 2 ) \\ {x}^{( 6 )} ( i ) = {d}^{( 1 )} ( 4 i + 3 )\end{matrix} {M}_{symb}^{layer} = {M}_{symb}^{( 0 )} / 3 = {M}_{symb}^{( 1 )} / 4$ |
| 8 | 2 | $\begin{matrix}{x}^{( 0 )} ( i ) = {d}^{( 0 )} ( 4 i ) \\ {x}^{( 1 )} ( i ) = {d}^{( 0 )} ( 4 i + 1 ) \\ {x}^{( 2 )} ( i ) = {d}^{( 0 )} ( 4 i + 2 ) \\ {x}^{( 3 )} ( i ) = {d}^{( 1 )} ( 4 i + 3 ) \\ {x}^{( 4 )} ( i ) = {d}^{( 1 )} ( 4 i ) \\ {x}^{( 5 )} ( i ) = {d}^{( 1 )} ( 4 i + 1 ) \\ {x}^{( 6 )} ( i ) = {d}^{( 1 )} ( 4 i + 2 ) \\ {x}^{( 7 )} ( i ) = {d}^{( 1 )} ( 4 i + 3 )\end{matrix} {M}_{symb}^{layer} = {M}_{symb}^{( 0 )} / 4 = {M}_{symb}^{( 1 )} / 4$ |

Aspects of signal enhancements for mixed downlink transmissions include and/or are directed to antenna panels and/or ports, quasi-collocation, TCI state, and spatial relation. In implementations described herein, the terms antenna, panel, and antenna panel are used interchangeably. An antenna panel may be hardware that is used for transmitting and/or receiving radio signals at frequencies lower than 6 GHz (e.g., frequency range 1 (FR1)), or higher than 6 GHz (e.g., frequency range 2 (FR2)) or millimeter wave (mmWave). In some implementations, an antenna panel includes an array of antenna elements, where each antenna element is connected to hardware, such as a phase shifter that allows a control module to apply spatial parameters for transmission and/or reception of signals. The resulting radiation pattern is called a beam, which may or may not be unimodal and allows the device to amplify signals that are transmitted or received from spatial directions.

In one or more implementations, an antenna panel may be virtualized as an antenna port in the specifications. An antenna panel can be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information is communicated via signaling or, in some implementations, capability information is provided to devices without a need for signaling. In the event that such information is available to other devices, it can be used for signaling or local decision making.

In one or more implementations, a device (e.g., a UE, a network node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel (or device panel) may be a logical entity with physical device antennas mapped to the logical entity. The mapping of physical device antennas to the logical entity can be based on device implementation. Communicating (e.g., receiving or transmitting) on at least a subset of antenna elements or antenna ports active for radiating energy (also referred to herein as active elements) of an antenna panel requires biasing or powering of the RF chain, which results in current drain or power consumption in the device associated with the antenna panel, including power amplifier and/or low noise amplifier (LNA) power consumption associated with the antenna elements or antenna ports. The phrase “active for radiating energy,” as used herein is not meant to be limited to a transmit function, but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In one or more implementations, and depending on the particular device implementation, a device panel can have at least one of the following functionalities as an operational role: a unit of an antenna group to control its transmit beam independently, a unit of an antenna group to control its transmission power independently, and/or a unit of an antenna group to control its transmission timing independently. The device panel may be transparent to a gNB. For certain condition(s), a gNB or a network node can assume the mapping between the physical antennas of a device to the logical entity “device panel” may not be changed. For example, the condition may include until the next update or report from a device, or include a duration of time over which the gNB assumes there will be no change to the mapping. A device may report its capability with respect to the device panel to the gNB or network. The device capability can include at least the number of device panels. In an implementation, the device may support UL transmission from one beam within a panel, and with multiple panels, more than one beam (e.g., one beam per panel) may be used for UL transmission. In another implementation, more than one beam per panel may be supported or used for UL transmission.

In some described implementations, an antenna port is defined such that the channel over which a symbol on the antenna port is conveyed can be inferred from the channel over which another symbol on the same antenna port is conveyed. Two antenna ports are QCL if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and/or spatial receive parameters. Two antenna ports may be quasi-located with respect to a subset of the large-scale properties, and a different subset of large-scale properties can be indicated by a QCL type. The QCL type can indicate which channel properties are the same between the two reference signals (e.g., on the two antenna ports). Thus, the reference signals can be linked to each other with respect to what the UE can assume about their channel statistics or QCL properties. For example, the QCL-type can be one of the following values: QCL-TypeA: {Doppler shift, Doppler spread, average delay, delay spread}; QCL-TypeB: {Doppler shift, Doppler spread}; QCL-TypeC: {Doppler shift, average delay}; QCL-TypeD: {Spatial Rx parameter}.

Spatial receive parameters can include one or more of angle of arrival (AoA) dominant AoA, average AoA, angular spread, power angular spectrum (PAS) of AoA, average AoD (angle of departure), PAS of AoD, transmit and/or receive channel correlation, transmit and/or receive beamforming, spatial channel correlation, etc. The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission (i.e., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same receive (RX) beamforming weights).

As described in this disclosure, an antenna port may be a logical port that corresponds to a beam (resulting from beamforming), or may correspond to a physical antenna on a device. In one or more implementations, a physical antenna can map directly to a single antenna port, in which an antenna port corresponds to an actual physical antenna. Alternately, a set or subset of physical antennas, or an antenna set or antenna array or antenna sub-array, may be mapped to one or more antenna ports after applying complex weights, a cyclic delay, or both to the signal on each physical antenna. The physical antenna set may have antennas from a single module or panel, or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some described implementations, a TCI-state associated with a target transmission can indicate parameters for configuring a quasi-collocation relationship between the target transmission (e.g., a target RS of DMRS ports of the target transmission during a transmission occasion) and one or more source reference signals (e.g., SSB, CSI-RS, and/or sounding reference signal (SRS)) with respect to quasi co-location type parameters indicated in the corresponding TCI state. The TCI describes which reference signals are used as a QCL source, and what QCL properties can be derived from each reference signal. A device can receive a configuration of a plurality of transmission configuration indicator states for a serving cell for transmissions on the serving cell. In some of the described implementations, a TCI state includes at least one source RS to provide a reference (UE assumption) for determining QCL and/or a spatial filter.

In one or more implementations, spatial relation information associated with a target transmission can indicate parameters for configuring a spatial setting between the target transmission and a reference RS (e.g., SSB, CSI-RS, and/or SRS). For example, the device can transmit the target transmission with the same spatial domain filter used for reception of the reference RS (e.g., DL RS such as SSB or CSI-RS). In another example, the device may transmit the target transmission with the same spatial domain transmission filter used for the transmission of the reference RS (e.g., UL RS, such as SRS). A device can receive a configuration of multiple spatial relation information configurations for a serving cell for transmissions on the serving cell.

In some described implementations, an UL TCI state is provided if a device is configured with separate DL/UL TCI by RRC signaling. The UL TCI state can include a source reference signal which provides a reference for determining an UL spatial domain transmission filter for the UL transmission (e.g., dynamic-grant or configured-grant based PUSCH, dedicated PUCCH resources) in a CC, or across a set of configured CCs and/or BWPs.

In some described implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides a QCL Type-D indication (e.g., for device-dedicated physical downlink control channel (PDCCH) and/or PDSCH) and is used to determine UL spatial transmission filter (e.g., for UE-dedicated PUSCH and/or PUCCH) for a CC, or across a set of configured CCs and/or BWPs. In an example, the UL spatial transmission filter is derived from the RS of DL QCL Type-D in the joint TCI state. The spatial setting of the UL transmission may be according to the spatial relation with a reference to the source RS configured with qcl-Type set to “typed” in the joint TCI state.

In aspects of signal enhancements for mixed downlink transmissions, the following notations are used interchangeably, including transmit-receive point (TRP), panel, set of antennas, set of antenna ports, uniform linear array, cell, node, radio head, communication (e.g., signals/channels) associated with a control resource set (CORESET), communication associated with a TCI state from a transmission configuration of at least two TCI states. The codebook type used for PMI reporting is arbitrary, and flexible in the use of different codebook types (e.g., Type-II Rel. 16 codebook, Type-II Rel. 17 codebook, Type-II Rel. 18 codebook, etc.). A TRS corresponds to an NZP CSI-RS resource set with a parameter ‘trs-info’ being configured. A CSI-RS for beam management corresponds to an NZP CSI-RS resource set with a parameter ‘repetition’ being configured. A CSI-RS for CSI corresponds to an NZP CSI-RS resource set with neither parameters ‘trs-info’ nor ‘repetition’ being configured. A matrix implies a sequence of fields of an arbitrary dimension, including an array (vector) of values, a standard 2D matrix and more generally a Q-dimensional matrix (tensor), where Q≥2 and is an integer value.

Aspects of the present disclosure include solutions for DCI triggering of eMBB-based and URLLC-based PDSCH. In examples, a DCI for scheduling PDSCH transmission is triggered. The DCI triggers transmission of two transport blocks associated with two codewords. The two codewords include a first codeword associated with an eMBB-based DL transmission and a second codeword associated with a URLLC-based DL transmission.

In an implementation for configuring two codewords, a configuration of a maximum number of codewords scheduled by the DCI is set to two. In an example, the number of codewords is set to two. In another example, the configuration corresponds to a higher-layer configuration of the PDSCH (i.e., PDSCH configuration).

In an implementation for configuring frequency domain resources, up to two parameters corresponding to a resource allocation type parameter are configured. In an example, a same value of a parameter corresponding to resource allocation type applies to both codewords. In another example, the up to two parameters are configured as part of a higher-layer configuration of the PDSCH (i.e., PDSCH configuration).

In an implementation for configuring time domain resources, up to two parameters corresponding to time-domain allocation are configured. In an example, a same value of a parameter corresponding to time-domain allocation is applied to both codewords. In another example, the up to two parameters are configured as part of a higher-layer configuration of the PDSCH (i.e., PDSCH configuration).

In an implementation for configuring a repetition scheme, a parameter corresponding to a repetition scheme is configured. In an example, the repetition scheme parameter is configured as part of a higher-layer configuration of the PDSCH (i.e., PDSCH configuration).

In an implementation for activating mixed codeword transmission, a parameter corresponding to a transmission of two transport blocks associated with two codewords is configured. The first codeword may be associated with an eMBB-based DL transmission and the second codeword may be associated with a URLLC-based DL transmission. In an example, the parameter is configured as part of a higher-layer configuration of the PDSCH (i.e., PDSCH configuration). In another example, the parameter is configured as a subset of a field of the DCI corresponding to a PDSCH scheduling format (e.g., Format 1_1, Format 1_2). In this example, a subset of bits of a field in the DCI indicates whether two codewords corresponding to eMBB-based transmission and URLLC-based transmission are scheduled. In yet another example, a DCI used for scheduling two PDSCH codewords has a DCI format indicating a joint eMBB-based transmission and URLLC-based transmission over two codewords-including a first codeword associated with eMBB-based DL transmission and a second codeword associated with URLLC-based DL transmission.

In an implementation, an eMBB-based DL transmission corresponds to a transmission of a first transport block. The first transport block is associated with a first threshold of a maximum error probability at which the first transport block can be received. In this implementation, a URLLC-based DL transmission corresponds to a transmission of a second transport block. The second transport block is associated with a second threshold of a maximum error probability at which the second transport block can be received. In some examples, a value of the first threshold is higher than a value of the second threshold. In an example, the value of the first threshold is 0.1, and the value of the second threshold is 0.00001. In another example, a ratio of the value of the first threshold to the value of the second threshold is 10×, wherein x is a positive integer value, e.g., x=2.

Aspects of the present disclosure include solutions for codeword-to-layer mapping. In implementations, a set of layers transmitted from one or more network nodes are mapped to two codewords (e.g., associated with the eMBB-based DL transmission and the URLLC-based DL transmission).

In an implementation for configuring a number of layers mapped to a first codeword, the first codeword associated with an eMBB-based DL transmission is restricted with a maximum number of PDSCH layers (e.g., up to four PDSCH layers).

In an implementation for configuring a number of layers mapped to a second codeword, the second codeword associated with a URLLC-based DL transmission is restricted with a maximum number of PDSCH layers (e.g., up to two PDSCH layers).

In an implementation for configuring layer pairs, a set of layer pairs associated with the two codewords comprises {(1,1), (1,2), (1,3), (1,4), (2,1), (2,2), (2,3), (2,4)}. In an example, a first value of a given layer pair corresponds to a number of layers of the first codeword associated with the eMBB-based DL transmission, and a second value of the given layer pair corresponds to a number of layers of the second codeword associated with URLLC-based DL transmission.

In an implementation for codeword-to-layer mapping, complex-valued modulation symbols for each of the two codewords to be transmitted are mapped onto one or several layers. In some examples, complex-valued modulation symbols

$${d}^{( q )} ( 0 ) , … , {d}^{( q )} ( {M}_{symb}^{( q )} - 1 )$$

for codeword q shall be mapped onto the layers

$$x ( i ) = {[ {x}^{( 0 )} ( i ) … {x}^{( υ - 1 )} ( i ) ]}^{T} , i = 0 , 1 , … , {M}_{symb}^{layer} - 1$$

where v is the number of layers and

$${M}_{symb}^{layer}$$

is the number of modulation symbols per layer. In an example, all URLLC layers are associated with a layer index value that precedes (i.e., is smaller than) a layer index value associated with any of the eMBB layers. In another example, a first layer index value is associated with a first URLLC layer, a second layer index value is associated with a first eMBB-based layer, one or more subsequent layer index values are associated with the remainder of URLLC layers, and one or more further subsequent layer index values are associated with eMBB layers. In yet another example, eMBB layers and URLLC layers are assigned in an alternating fashion (e.g., where a first layer is a URLLC layer). Example codeword-to-layer mappings for spatial multiplexing are provided in Table 8.

TABLE 8
codeword-to-layer mapping for spatial multiplexing (e.g., of two
eMBB/URLLC codeword transmissions).

| | Codeword-to-layer mapping |
|---|---|
| Layer pairs of the two codewords | $i = 0 , 1 , … , {M}_{symb}^{layer} - 1$ |
| (1, 1) | $\begin{matrix}{x}^{( 0 )} ( i ) = {d}^{( 0 )} ( i ) \\ {x}^{( 1 )} ( i ) = {d}^{( 1 )} ( i )\end{matrix} {M}_{symb}^{layer} = {M}_{symb}^{( 0 )} = {M}_{symb}^{( 1 )}$ |
| (1, 2) | $\begin{matrix}{x}^{( 0 )} ( i ) = {d}^{( 0 )} ( i ) \\ {x}^{( 1 )} ( i ) = {d}^{( 1 )} ( 2 i ) \\ {x}^{( 2 )} ( i ) = {d}^{( 1 )} ( 2 i + 1 )\end{matrix} {M}_{symb}^{layer} = {M}_{symb}^{( 0 )} = {M}_{symb}^{( 1 )} / 2$ |
| (1, 3) | $\begin{matrix}{x}^{( 0 )} ( i ) = {d}^{( 0 )} ( i ) \\ {x}^{( 1 )} ( i ) = {d}^{( 1 )} ( 3 i ) \\ {x}^{( 2 )} ( i ) = {d}^{( 1 )} ( 3 i + 1 ) \\ {x}^{( 3 )} ( i ) = {d}^{( 1 )} ( 3 i + 2 )\end{matrix} {M}_{symb}^{layer} = {M}_{symb}^{( 0 )} = {M}_{symb}^{( 1 )} / 3$ |
| (1, 4) | $\begin{matrix}{x}^{( 0 )} ( i ) = {d}^{( 0 )} ( i ) \\ {x}^{( 1 )} ( i ) = {d}^{( 1 )} ( 4 i ) \\ {x}^{( 2 )} ( i ) = {d}^{( 1 )} ( 4 i + 1 ) \\ {x}^{( 3 )} ( i ) = {d}^{( 1 )} ( 4 i + 2 ) \\ {x}^{( 4 )} ( i ) = {d}^{( 1 )} ( 4 i + 3 )\end{matrix} {M}_{symb}^{layer} = {M}_{symb}^{( 0 )} = {M}_{symb}^{( 1 )} / 4$ |
| (2, 1) | $\begin{matrix}{x}^{( 0 )} ( i ) = {d}^{( 0 )} ( 2 i ) \\ {x}^{( 1 )} ( i ) = {d}^{( 0 )} ( 2 i + 1 ) \\ {x}^{( 2 )} ( i ) = {d}^{( 1 )} ( i )\end{matrix} {M}_{symb}^{layer} = {M}_{symb}^{( 0 )} / 2 = {M}_{symb}^{( 1 )}$ |
| (2, 2) | $\begin{matrix}{x}^{( 0 )} ( i ) = {d}^{( 0 )} ( 2 i ) \\ {x}^{( 1 )} ( i ) = {d}^{( 0 )} ( 2 i + 1 ) \\ {x}^{( 2 )} ( i ) = {d}^{( 1 )} ( 2 i ) \\ {x}^{( 3 )} ( i ) = {d}^{( 1 )} ( 2 i + 1 )\end{matrix} {M}_{symb}^{layer} = {M}_{symb}^{( 0 )} / 2 = {M}_{symb}^{( 1 )} / 2$ |
| (2, 3) | $\begin{matrix}{x}^{( 0 )} ( i ) = {d}^{( 0 )} ( 2 i ) \\ {x}^{( 1 )} ( i ) = {d}^{( 0 )} ( 2 i + 1 ) \\ {x}^{( 2 )} ( i ) = {d}^{( 1 )} ( 3 i ) \\ {x}^{( 3 )} ( i ) = {d}^{( 1 )} ( 3 i + 1 ) \\ {x}^{( 4 )} ( i ) = {d}^{( 1 )} ( 3 i + 2 )\end{matrix} {M}_{symb}^{layer} = {M}_{symb}^{( 0 )} / 2 = {M}_{symb}^{( 1 )} / 3$ |
| (2, 4) | $\begin{matrix}{x}^{( 0 )} ( i ) = {d}^{( 0 )} ( 2 i ) \\ {x}^{( 1 )} ( i ) = {d}^{( 0 )} ( 2 i + 1 ) \\ {x}^{( 2 )} ( i ) = {d}^{( 1 )} ( 4 i ) \\ {x}^{( 3 )} ( i ) = {d}^{( 1 )} ( 4 i + 1 ) \\ {x}^{( 4 )} ( i ) = {d}^{( 1 )} ( 4 i + 2 ) \\ {x}^{( 5 )} ( i ) = {d}^{( 1 )} ( 4 i + 3 )\end{matrix} {M}_{symb}^{layer} = {M}_{symb}^{( 0 )} / 2 = {M}_{symb}^{( 1 )} / 4$ |

Aspects of the present disclosure include solutions for TCI state indication for joint eMBB-URLLC DL transmission. In implementations, a set of PDSCH-based DMRS ports are associated with the aggregate PDSCH layers corresponding to the eMBB and URLLC codewords transmitted from one or more network nodes.

In an implementation, the set of PDSCH-based DMRS ports include two groups of PDSCH-based DMRS ports. In examples, the two groups of PDSCH-based DMRS ports include a first group of PDSCH-based DMRS ports associated with an eMBB-based codeword, and a second group of PDSCH-based DMRS ports associated with the URLLC-based codeword. In an example, the two groups of PDSCH-based DMRS ports are associated with two CDM groups. In another example, a number of PDSCH-based DMRS ports of the first group is equal to a number of layers of the eMBB-based codeword, and a number of PDSCH-based DMRS ports of the second group is equal to a number of layers of the URLLC-based codeword.

In an implementation, a single NZP CSI-RS resource for channel measurement is associated with the set of PDSCH-based DMRS ports. In examples, the NZP CSI-RS resource includes two groups of CSI-RS ports. In an example, each of the two groups of CSI-RS ports is associated with a distinct CDM group (or alternatively a distinct set of CDM groups). In another example, a first group of CSI-RS ports is QCL with the first DMRS port group (e.g., with respect to Type-A and Type-D if applicable), and a second group of CSI-RS ports is QCL with the second DMRS port group (e.g., with respect to Type-A and/or Type-D if applicable). In yet another example, a first group of CSI-RS ports is QCL with the first DMRS port group (e.g., with respect to Type-A and/or Type-D if applicable), and both the first group of CSI-RS ports and a second group of CSI-RS ports are QCL with the second group of DMRS ports (e.g., with respect to Type-A and Type-D if applicable). For instance, DMRS port group 1 (maps to eMBB layers) may be QCL with CSI-RS port group 1; and DMRS port group 2 (maps to URLLC layers) may be QCL with both CSI-RS port group 1 and CSI-RS port group 2.

In an implementation, two NZP CSI-RS resources for channel measurement are associated with the two groups of DMRS ports. In an example, a first CSI-RS resource is QCL with the first DMRS port group (e.g., with respect to Type-A and Type-D if applicable). Further, in this example, the first CSI-RS resource and a second CSI-RS resource are QCL with the second DMRS port group (e.g., with respect to Type-A and Type-D if applicable). In another example, the first CSI-RS resource includes two CSI-RS port groups. In this example, a first CSI-RS port group of the first CSI-RS resource is QCL with the first DMRS port group (e.g., with respect to Type-A and

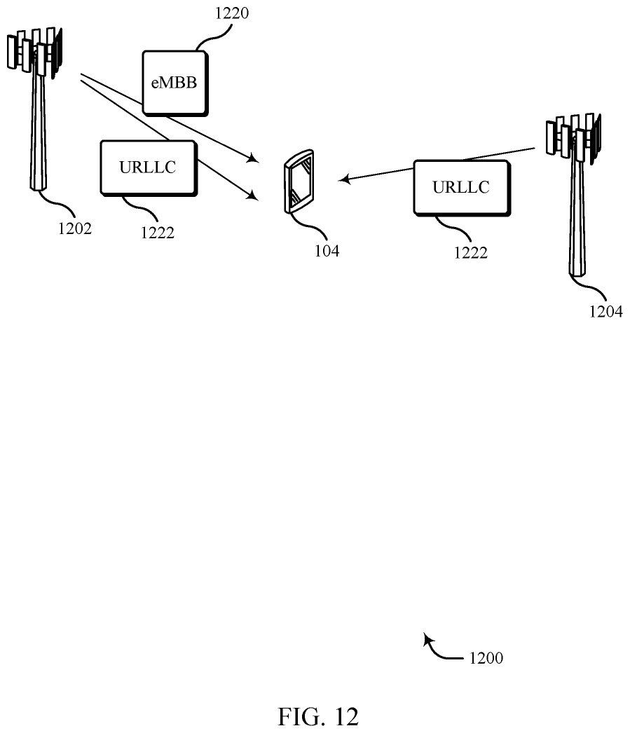

Type-D if applicable). Furthermore, in this example, both CSI-RS port groups of the first CSI-RS resource and the second CSI-RS resource are QCL with the second DMRS port group (e.g., with respect to Type-A and Type-D if applicable). In yet another example, the first CSI-RS resource and the second CSI-RS resource are associated with a first network node and a second network node (i.e., two TRPs). In this example, the first network node is associated with transmission of both the eMBB-based codeword and the URLLC-based codeword, and the second network node is associated with transmission of the URLLC-based codeword. An illustration of this example is provided in FIG. 12.

FIG. 12 illustrates an example of a wireless communication system 1200 in which two transmission reception points (TRPs) 1202 and 1204 are communicating an eMBB-based codeword 1220 and a URLLC-based codeword 1222 to a UE 104, as related to signal enhancements for mixed downlink transmissions in accordance with aspects of the present disclosure. In the illustrated example, a first group of DMRS ports (e.g., mapped to eMBB layers) may be QCL with a first group of CSI-RS ports of a first CSI-RS resource (e.g., TRP 1202). Further, a second group of DMRS ports (mapped to URLLC layers) is QCL with a second CSI-RS resource (e.g., TRP 1204) and a second group of CSI-RS ports of the first CSI-RS resource (e.g., TRP 1202).

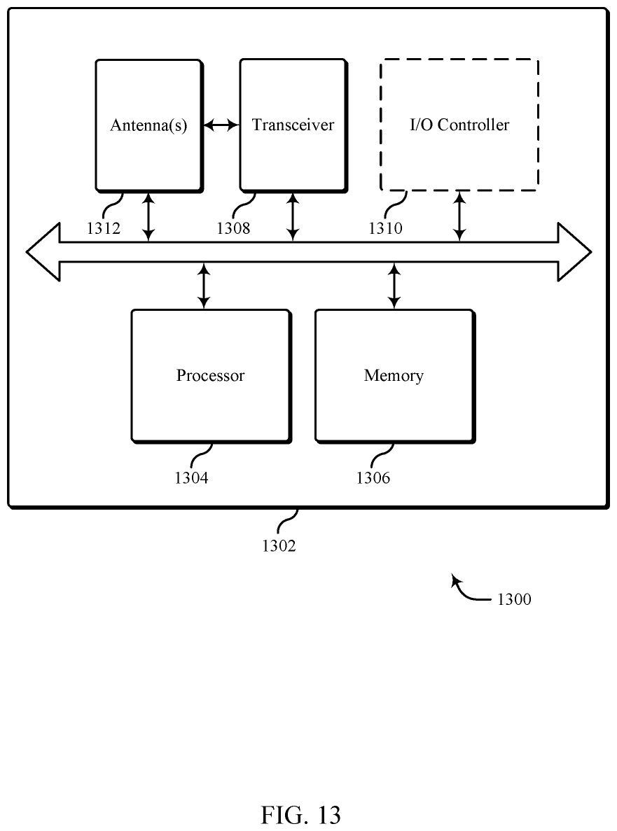

FIG. 13 illustrates an example of a block diagram 1300 of a device 1302 that supports signal enhancements for mixed downlink transmissions in accordance with aspects of the present disclosure. The device 1302 may be an example of a UE 104 as described herein. The device 1302 may support wireless communication with one or more network entities 102, UEs 104, or any combination thereof. The device 1302 may include components for bi-directional communications including components for transmitting and receiving communications, such as a processor 1304, a memory 1306, a transceiver 1308, and an I/O controller 1310. These components may be in electronic communication or otherwise coupled (e.g., operatively, communicatively, functionally, electronically, electrically) via one or more interfaces (e.g., buses).

The processor 1304, the memory 1306, the transceiver 1308, or various combinations thereof or various components thereof may be examples of means for performing various aspects of the present disclosure as described herein. For example, the processor 1304, the memory 1306, the transceiver 1308, or various combinations or components thereof may support a method for performing one or more of the operations described herein.

In some implementations, the processor 1304, the memory 1306, the transceiver 1308, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1304 and the memory 1306 coupled with the processor 1304 may be configured to perform one or more of the functions described herein (e.g., executing, by the processor 1304, instructions stored in the memory 1306).

For example, the processor 1304 may support wireless communication at the device 1302 in accordance with examples as disclosed herein. The processor 1304 may be configured as or otherwise support a means for receiving, from at least one network entity, a first signaling as a PDSCH configuration; receiving, from the at least one network entity, a second signaling as a DCI for scheduling communication of two TBs to the apparatus over a PDSCH, the two TBs associated with different threshold TB error probabilities; and receiving over the PDSCH from the at least one network entity, based at least in part on the DCI and the PDSCH configuration, a first set of PDSCH data layers indicating a first codeword for a first TB of the two TBs and a second set of PDSCH data layers indicating a second codeword for a second TB of the two TBs.

Additionally, the processor 1304 may be configured as or otherwise support any one or combination of at least one of the first signaling or the second signaling includes TCI state information. The TCI state information indicating a mapping of a downlink reference signal with a set of DMRS ports. Each of the DMRS ports associated with a different PDSCH data layer. The set of DMRS ports includes a first group of DMRS ports associated with the first codeword and a second group of DMRS ports associated with the second codeword. The first group of DMRS ports is associated with a first CDM group. The second group of DMRS ports is associated with a second CDM group different than the first CDM group. A number of the DMRS ports in the first group of DMRS ports is equal to a number of the PDSCH data layers in the first set of PDSCH data layers. A number of the DMRS ports in the second group of DMRS ports is equal to a number of the PDSCH data layers in the second set of PDSCH data layers. The downlink reference signal includes a NZP CSI-RS resource for channel measurement. The NZP CSI-RS resource includes a first group of CSI-RS ports and a second group of CSI-RS ports. The first group of DMRS ports is quasi-co-located with the first group of CSI-RS ports. The second group of DMRS ports is quasi-co-located with the second group of CSI-RS ports. The first group of DMRS ports is quasi-co-located with the first group of CSI-RS ports. The second group of DMRS ports is quasi-co-located with the first group of CSI-RS ports and the second group of CSI-RS ports. The downlink reference signal comprises a first NZP CSI-RS resource and a second NZP CSI-RS resource for channel measurement. The first group of DMRS ports is quasi-co-located with the first NZP CSI-RS resource. The second group of DMRS ports is quasi-co-located with the first NZP CSI-RS resource and the second NZP CSI-RS resource. The first NZP CSI-RS resource includes a first group of CSI-RS ports and a second group of CSI-RS ports. The first group of DMRS ports is quasi-co-located with the first group of CSI-RS ports. The second group of DMRS ports is quasi-co-located with the second group of CSI-RS ports and the second NZP CSI-RS resource. A number of layers in the first set of PDSCH data layers of the first TB is less than or equal to four layers. A number of layers in the second set of PDSCH data layers of the second TB is less than or equal to two layers. Values of indices associated with the second set of PDSCH data layers are smaller than values of indices associated with the first set of PDSCH data layers. The first signaling includes at least one of: an indication that the apparatus is scheduled to receive the first codeword and the second codeword over the PDSCH, a resource allocation type parameter, a time-domain allocation type parameter, or a repetition scheme configuration. The second signaling includes an indication that the apparatus is scheduled to receive the first codeword corresponding to the first TB, and the second codeword corresponding to the second TB. The indication is provided in at least one of a field of the DCI, or a subset of a field of the DCI. The DCI has a DCI format indicating that the apparatus is scheduled to receive the two TBs associated with the different threshold TB error probabilities. The first TB is associated with a first threshold TB error probability that is higher than a second threshold TB error probability associated with the second TB. The first TB corresponds to a mobile broadband communication mode. The second TB corresponds to at least one of a high reliability communication mode or a low latency communication mode.

Additionally, or alternatively, the device 1302, in accordance with examples as disclosed herein, may include the processor 1304 and the memory 1306 coupled with the processor 1304, the processor 1304 configured to cause the device 1302 to: receive, from at least one network entity, a first signaling as a physical PDSCH configuration; receive, from the at least one network entity, a second signaling as a DCI for scheduling communication of two transport blocks TBs to the apparatus over a PDSCH, the two TBs associated with different threshold TB error probabilities; and receive over the PDSCH from the at least one network entity, based at least in part on the DCI and the PDSCH configuration, a first set of PDSCH data layers indicating a first codeword for a first TB of the two TBs and a second set of PDSCH data layers indicating a second codeword for a second TB of the two TBs.

Additionally, the wireless communication at the device 1302 may include any one or combination of at least one of the first signaling or the second signaling includes TCI state information. The TCI state information indicating a mapping of a downlink reference signal with a set of DMRS ports. Each of the DMRS ports associated with a different PDSCH data layer. The set of DMRS ports includes a first group of DMRS ports associated with the first codeword and a second group of DMRS ports associated with the second codeword. The first group of DMRS ports is associated with a first CDM group. The second group of DMRS ports is associated with a second CDM group different than the first CDM group. A number of the DMRS ports in the first group of DMRS ports is equal to a number of the PDSCH data layers in the first set of PDSCH data layers. A number of the DMRS ports in the second group of DMRS ports is equal to a number of the PDSCH data layers in the second set of PDSCH data layers. The downlink reference signal includes a NZP CSI-RS resource for channel measurement. The NZP CSI-RS resource includes a first group of CSI-RS ports and a second group of CSI-RS ports. The first group of DMRS ports is quasi-co-located with the first group of CSI-RS ports. The second group of DMRS ports is quasi-co-located with the second group of CSI-RS ports. The first group of DMRS ports is quasi-co-located with the first group of CSI-RS ports. The second group of DMRS ports is quasi-co-located with the first group of CSI-RS ports and the second group of CSI-RS ports. The downlink reference signal comprises a first NZP CSI-RS resource and a second NZP CSI-RS resource for channel measurement. The first group of DMRS ports is quasi-co-located with the first NZP CSI-RS resource. The second group of DMRS ports is quasi-co-located with the first NZP CSI-RS resource and the second NZP CSI-RS resource. The first NZP CSI-RS resource includes a first group of CSI-RS ports and a second group of CSI-RS ports. The first group of DMRS ports is quasi-co-located with the first group of CSI-RS ports. The second group of DMRS ports is quasi-co-located with the second group of CSI-RS ports and the second NZP CSI-RS resource. A number of layers in the first set of PDSCH data layers of the first TB is less than or equal to four layers. A number of layers in the second set of PDSCH data layers of the second TB is less than or equal to two layers. Values of indices associated with the second set of PDSCH data layers are smaller than values of indices associated with the first set of PDSCH data layers. The first signaling includes at least one of: an indication that the apparatus is scheduled to receive the first codeword and the second codeword over the PDSCH, a resource allocation type parameter, a time-domain allocation type parameter, or a repetition scheme configuration. The second signaling includes an indication that the apparatus is scheduled to receive the first codeword corresponding to the first TB, and the second codeword corresponding to the second TB. The indication is provided in at least one of a field of the DCI, or a subset of a field of the DCI. The DCI has a DCI format indicating that the apparatus is scheduled to receive the two TBs associated with the different threshold TB error probabilities. The first TB is associated with a first threshold TB error probability that is higher than a second threshold TB error probability associated with the second TB. The first TB corresponds to a mobile broadband communication mode. The second TB corresponds to at least one of a high reliability communication mode or a low latency communication mode.

The processor 1304 of the device 1302, such as a UE 104, may support wireless communication in accordance with examples as disclosed herein. The processor 1304 includes at least one controller coupled with at least one memory, and is configured to or operable to cause the processor to receive, from at least one network entity, a first signaling as a PDSCH configuration; receive, from the at least one network entity, a second signaling as a DCI for scheduling communication of two TBs over a PDSCH, the two TBs associated with different threshold TB error probabilities; and receive over the PDSCH from the at least one network entity, based at least in part on the DCI and the PDSCH configuration, a first set of PDSCH data layers indicating a first codeword for a first TB of the two TBs and a second set of PDSCH data layers indicating a second codeword for a second TB of the two TBs.

The processor 1304 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1304 may be configured to operate a memory array using a memory controller. In some other implementations, a memory controller may be integrated into the processor 1304. The processor 1304 may be configured to execute computer-readable instructions stored in a memory (e.g., the memory 1306) to cause the device 1302 to perform various functions of the present disclosure.

The memory 1306 may include random access memory (RAM) and read-only memory (ROM). The memory 1306 may store computer-readable, computer-executable code including instructions that, when executed by the processor 1304 cause the device 1302 to perform various functions described herein. The code may be stored in a non-transitory computer-readable medium such as system memory or another type of memory. In some implementations, the code may not be directly executable by the processor 1304 but may cause a computer (e.g., when compiled and executed) to perform functions described herein. In some implementations, the memory 1306 may include, among other things, a basic I/O system (BIOS) which may control basic hardware or software operation such as the interaction with peripheral components or devices.

The I/O controller 1310 may manage input and output signals for the device 1302. The I/O controller 1310 may also manage peripherals not integrated into the device M02. In some implementations, the I/O controller 1310 may represent a physical connection or port to an external peripheral. In some implementations, the I/O controller 1310 may utilize an operating system such as iOS®, ANDROID®, MS-DOS®, MS-WINDOWS®, OS/2®, UNIX®, LINUX®, or another known operating system. In some implementations, the I/O controller 1310 may be implemented as part of a processor, such as the processor 1304. In some implementations, a user may interact with the device 1302 via the I/O controller 1310 or via hardware components controlled by the I/O controller 1310.

In some implementations, the device 1302 may include a single antenna 1312. However, in some other implementations, the device 1302 may have more than one antenna 1312 (i.e., multiple antennas), including multiple antenna panels or antenna arrays, which may be capable of concurrently transmitting or receiving multiple wireless transmissions. The transceiver 1308 may communicate bi-directionally, via the one or more antennas 1312, wired, or wireless links as described herein. For example, the transceiver 1308 may represent a wireless transceiver and may communicate bi-directionally with another wireless transceiver. The transceiver 1308 may also include a modem to modulate the packets, to provide the modulated packets to one or more antennas 1312 for transmission, and to demodulate packets received from the one or more antennas 1312.

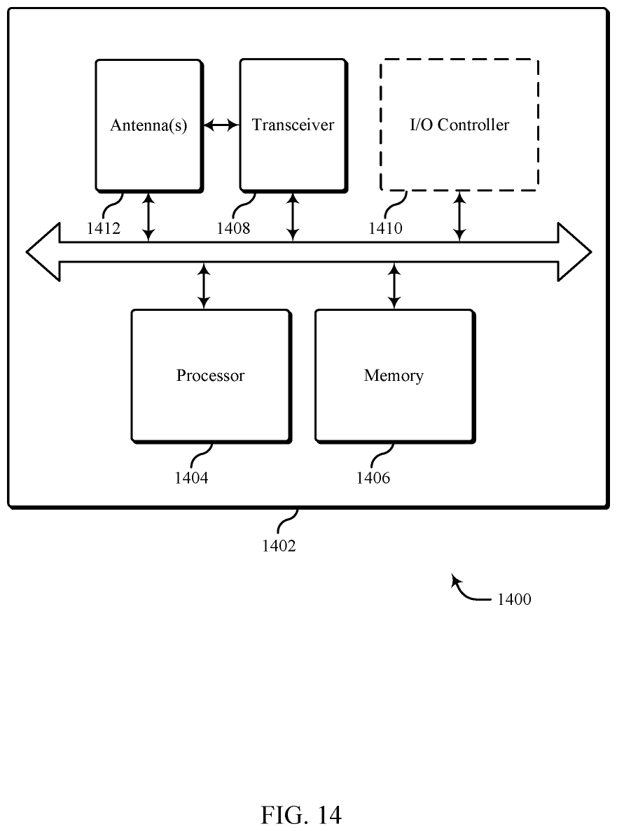

FIG. 14 illustrates an example of a block diagram 1400 of a device 1402 that supports signal enhancements for mixed downlink transmissions in accordance with aspects of the present disclosure. The device 1402 may be an example of a network entity 102 as described herein. The device 1402 may support wireless communication with one or more network entities 102, UEs 104, or any combination thereof. The device 1402 may include components for bi-directional communications including components for transmitting and receiving communications, such as a processor 1404, a memory 1406, a transceiver 1408, and an I/O controller 1410. These components may be in electronic communication or otherwise coupled (e.g., operatively, communicatively, functionally, electronically, electrically) via one or more interfaces (e.g., buses).

The processor 1404, the memory 1406, the transceiver 1408, or various combinations thereof or various components thereof may be examples of means for performing various aspects of the present disclosure as described herein. For example, the processor 1404, the memory 1406, the transceiver 1408, or various combinations or components thereof may support a method for performing one or more of the operations described herein.

In some implementations, the processor 1404, the memory 1406, the transceiver 1408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1404 and the memory 1406 coupled with the processor 1404 may be configured to perform one or more of the functions described herein (e.g., executing, by the processor 1404, instructions stored in the memory 1406).

For example, the processor 1404 may support wireless communication at the device 1402 in accordance with examples as disclosed herein. The processor 1404 may be configured as or otherwise support a means for transmitting a first signaling as a PDSCH configuration; transmitting a second signaling as a DCI for scheduling transmission of two TBs to a UE over a PDSCH, the two TBs associated with different threshold TB error probabilities; and transmitting over the PDSCH, according to the DCI and the PDSCH configuration, a first set of PDSCH data layers indicating a first codeword for a first TB of the two TBs and a second set of PDSCH data layers indicating a second codeword for a second TB of the two TBs.

Additionally, the processor 1404 may be configured as or otherwise support any one or combination of at least one of the first signaling or the second signaling includes TCI state information. The TCI state information indicating a mapping of a downlink reference signal with a set of DMRS ports. Each of the DMRS ports associated with a different PDSCH data layer. The set of DMRS ports includes a first group of DMRS ports associated with the first codeword and a second group of DMRS ports associated with the second codeword. The first group of DMRS ports is associated with a first CDM group. The second group of DMRS ports is associated with a second CDM group different than the first CDM group. A number of the DMRS ports in the first group of DMRS ports is equal to a number of the PDSCH data layers in the first set of PDSCH data layers. A number of the DMRS ports in the second group of DMRS ports is equal to a number of the PDSCH data layers in the second set of PDSCH data layers. The downlink reference signal includes a NZP CSI-RS resource for channel measurement. The NZP CSI-RS resource includes a first group of CSI-RS ports and a second group of CSI-RS ports. The first group of DMRS ports is quasi-co-located with the first group of CSI-RS ports. The second group of DMRS ports is quasi-co-located with the second group of CSI-RS ports. The first group of DMRS ports is quasi-co-located with the first group of CSI-RS ports. The second group of DMRS ports is quasi-co-located with the first group of CSI-RS ports and the second group of CSI-RS ports. The downlink reference signal comprises a first NZP CSI-RS resource and a second NZP CSI-RS resource for channel measurement. The first group of DMRS ports is quasi-co-located with the first NZP CSI-RS resource. The second group of DMRS ports is quasi-co-located with the first NZP CSI-RS resource and the second NZP CSI-RS resource. The first NZP CSI-RS resource includes a first group of CSI-RS ports and a second group of CSI-RS ports. The first group of DMRS ports is quasi-co-located with the first group of CSI-RS ports. The second group of DMRS ports is quasi-co-located with the second group of CSI-RS ports and the second NZP CSI-RS resource. A number of layers in the first set of PDSCH data layers of the first TB is less than or equal to four layers. A number of layers in the second set of PDSCH data layers of the second TB is less than or equal to two layers. Values of indices associated with the second set of PDSCH data layers are smaller than values of indices associated with the first set of PDSCH data layers. The first signaling includes at least one of: an indication that the apparatus is scheduled to receive the first codeword and the second codeword over the PDSCH, a resource allocation type parameter, a time-domain allocation type parameter, or a repetition scheme configuration. The second signaling includes an indication that the apparatus is scheduled to receive the first codeword corresponding to the first TB, and the second codeword corresponding to the second TB. The indication is provided in at least one of a field of the DCI, or a subset of a field of the DCI. The DCI has a DCI format indicating that the apparatus is scheduled to receive the two TBs associated with the different threshold TB error probabilities. The first TB is associated with a first threshold TB error probability that is higher than a second threshold TB error probability associated with the second TB. The first TB corresponds to a mobile broadband communication mode. The second TB corresponds to at least one of a high reliability communication mode or a low latency communication mode.

Additionally, or alternatively, the device 1402, in accordance with examples as disclosed herein, may include a processor and a memory coupled with the processor, the processor configured to cause the apparatus to: transmit a first signaling as a PDSCH configuration; transmit a second signaling as a DCI for scheduling transmission of two TBs to a UE over a PDSCH, the two TBs associated with different threshold TB error probabilities; and transmit over the PDSCH, according to the DCI and the PDSCH configuration, a first set of PDSCH data layers indicating a first codeword for a first TB of the two TBs and a second set of PDSCH data layers indicating a second codeword for a second TB of the two TBs.

Additionally, the wireless communication at the device 1402 may include any one or combination of at least one of the first signaling or the second signaling includes TCI state information. The TCI state information indicating a mapping of a downlink reference signal with a set of DMRS ports. Each of the DMRS ports associated with a different PDSCH data layer. The set of DMRS ports includes a first group of DMRS ports associated with the first codeword and a second group of DMRS ports associated with the second codeword. The first group of DMRS ports is associated with a first CDM group. The second group of DMRS ports is associated with a second CDM group different than the first CDM group. A number of the DMRS ports in the first group of DMRS ports is equal to a number of the PDSCH data layers in the first set of PDSCH data layers. A number of the DMRS ports in the second group of DMRS ports is equal to a number of the PDSCH data layers in the second set of PDSCH data layers. The downlink reference signal includes a NZP CSI-RS resource for channel measurement. The NZP CSI-RS resource includes a first group of CSI-RS ports and a second group of CSI-RS ports. The first group of DMRS ports is quasi-co-located with the first group of CSI-RS ports. The second group of DMRS ports is quasi-co-located with the second group of CSI-RS ports. The first group of DMRS ports is quasi-co-located with the first group of CSI-RS ports. The second group of DMRS ports is quasi-co-located with the first group of CSI-RS ports and the second group of CSI-RS ports. The downlink reference signal comprises a first NZP CSI-RS resource and a second NZP CSI-RS resource for channel measurement. The first group of DMRS ports is quasi-co-located with the first NZP CSI-RS resource. The second group of DMRS ports is quasi-co-located with the first NZP CSI-RS resource and the second NZP CSI-RS resource. The first NZP CSI-RS resource includes a first group of CSI-RS ports and a second group of CSI-RS ports. The first group of DMRS ports is quasi-co-located with the first group of CSI-RS ports. The second group of DMRS ports is quasi-co-located with the second group of CSI-RS ports and the second NZP CSI-RS resource. A number of layers in the first set of PDSCH data layers of the first TB is less than or equal to four layers. A number of layers in the second set of PDSCH data layers of the second TB is less than or equal to two layers. Values of indices associated with the second set of PDSCH data layers are smaller than values of indices associated with the first set of PDSCH data layers. The first signaling includes at least one of: an indication that the apparatus is scheduled to receive the first codeword and the second codeword over the PDSCH, a resource allocation type parameter, a time-domain allocation type parameter, or a repetition scheme configuration. The second signaling includes an indication that the apparatus is scheduled to receive the first codeword corresponding to the first TB, and the second codeword corresponding to the second TB. The indication is provided in at least one of a field of the DCI, or a subset of a field of the DCI. The DCI has a DCI format indicating that the apparatus is scheduled to receive the two TBs associated with the different threshold TB error probabilities. The first TB is associated with a first threshold TB error probability that is higher than a second threshold TB error probability associated with the second TB. The first TB corresponds to a mobile broadband communication mode. The second TB corresponds to at least one of a high reliability communication mode or a low latency communication mode.

The processor 1404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1404 may be configured to operate a memory array using a memory controller. In some other implementations, a memory controller may be integrated into the processor 1404. The processor 1404 may be configured to execute computer-readable instructions stored in a memory (e.g., the memory 1406) to cause the device 1402 to perform various functions of the present disclosure.

The memory 1406 may include random access memory (RAM) and read-only memory (ROM). The memory 1406 may store computer-readable, computer-executable code including instructions that, when executed by the processor 1404 cause the device 1402 to perform various functions described herein. The code may be stored in a non-transitory computer-readable medium such as system memory or another type of memory. In some implementations, the code may not be directly executable by the processor 1404 but may cause a computer (e.g., when compiled and executed) to perform functions described herein. In some implementations, the memory 1406 may include, among other things, a basic I/O system (BIOS) which may control basic hardware or software operation such as the interaction with peripheral components or devices.

The I/O controller 1410 may manage input and output signals for the device 1402. The I/O controller 1410 may also manage peripherals not integrated into the device 1402. In some implementations, the I/O controller 1410 may represent a physical connection or port to an external peripheral. In some implementations, the I/O controller 1410 may utilize an operating system such as iOS®, ANDROID®, MS-DOS®, MS-WINDOWS®, OS/2®, UNIX®, LINUX®, or another known operating system. In some implementations, the I/O controller 1410 may be implemented as part of a processor, such as the processor 1404. In some implementations, a user may interact with the device 1402 via the I/O controller 1410 or via hardware components controlled by the I/O controller 1410.

In some implementations, the device 1402 may include a single antenna 1412. However, in some other implementations, the device 1402 may have more than one antenna 1412 (i.e., multiple antennas), including multiple antenna panels or antenna arrays, which may be capable of concurrently transmitting or receiving multiple wireless transmissions. The transceiver 1408 may communicate bi-directionally, via the one or more antennas 1412, wired, or wireless links as described herein. For example, the transceiver 1408 may represent a wireless transceiver and may communicate bi-directionally with another wireless transceiver. The transceiver 1408 may also include a modem to modulate the packets, to provide the modulated packets to one or more antennas 1412 for transmission, and to demodulate packets received from the one or more antennas 1412.

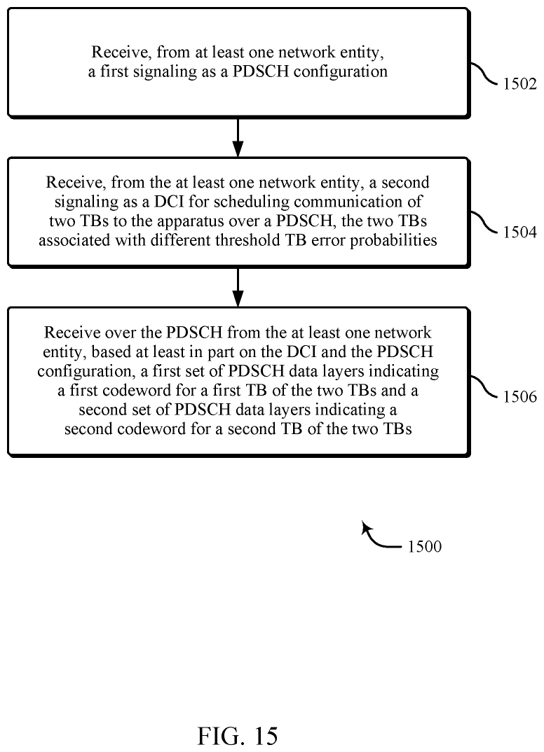

FIG. 15 illustrates a flowchart of a method 1500 that supports signal enhancements for mixed downlink transmissions in accordance with aspects of the present disclosure. The operations of the method 1500 may be implemented by a device or its components as described herein. For example, the operations of the method 1500 may be performed by a UE 104 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1502, the method may include receiving, from at least one network entity, a first signaling as a PDSCH configuration. The operations of 1502 may be performed in accordance with examples as described herein. In some implementations, aspects of the operations of 1502 may be performed by a device as described with reference to FIG. 1.

At 1504, the method may include receiving, from the at least one network entity, a second signaling as a DCI for scheduling communication of two TBs to the apparatus over a PDSCH, the two TBs associated with different threshold TB error probabilities. The operations of 1504 may be performed in accordance with examples as described herein. In some implementations, aspects of the operations of 1504 may be performed by a device as described with reference to FIG. 1.

At 1506, the method may include receiving over the PDSCH from the at least one network entity, based at least in part on the DCI and the PDSCH configuration, a first set of PDSCH data layers indicating a first codeword for a first TB of the two TBs and a second set of PDSCH data layers indicating a second codeword for a second TB of the two TBs. The operations of 1506 may be performed in accordance with examples as described herein. In some implementations, aspects of the operations of 1506 may be performed by a device as described with reference to FIG. 1.

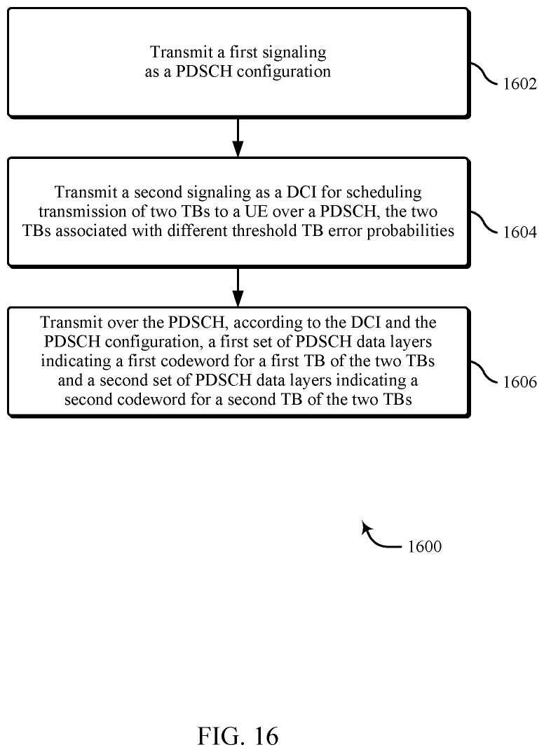

FIG. 16 illustrates a flowchart of a method 1600 that supports signal enhancements for mixed downlink transmissions in accordance with aspects of the present disclosure. The operations of the method 1600 may be implemented by a device or its components as described herein. For example, the operations of the method 1600 may be performed by a network entity 102 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1602, the method may include transmitting a first signaling as a PDSCH configuration. The operations of 1602 may be performed in accordance with examples as described herein. In some implementations, aspects of the operations of 1602 may be performed by a device as described with reference to FIG. 1.

At 1604, the method may include transmitting a second signaling as a DCI for scheduling transmission of two TBs to a UE over a PDSCH, the two TBs associated with different threshold TB error probabilities. The operations of 1604 may be performed in accordance with examples as described herein. In some implementations, aspects of the operations of 1604 may be performed by a device as described with reference to FIG. 1.

At 1606, the method may include transmitting over the PDSCH, according to the DCI and the PDSCH configuration, a first set of PDSCH data layers indicating a first codeword for a first TB of the two TBs and a second set of PDSCH data layers indicating a second codeword for a second TB of the two TBs. The operations of 1606 may be performed in accordance with examples as described herein. In some implementations, aspects of the operations of 1606 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive a physical downlink shared channel (PDSCH) configuration;
receive downlink control information (DCI) for scheduling communication of two transport blocks (TBs) to the UE over a PDSCH, the two TBs associated with different threshold transport block (TB) error probabilities; and
receive over the PDSCH, based at least in part on the DCI and the PDSCH configuration, a first set of PDSCH data layers indicating a first codeword for a first TB of the two TBs and a second set of PDSCH data layers indicating a second codeword for a second TB of the two TBs.

2. The UE of claim 1, wherein the at least one processor is operable to cause the UE to receive transmission configuration indicator (TCI) state information, the TCI state information indicating a mapping of a downlink reference signal with a set of demodulation reference signal (DMRS) ports, and each of the DMRS ports associated with a different PDSCH data layer.

3. The UE of claim 2, wherein the set of DMRS ports includes a first group of DMRS ports associated with the first codeword and a second group of DMRS ports associated with the second codeword.

4. The UE of claim 3, wherein:
the first group of DMRS ports is associated with a first code division multiplexing (CDM) group, wherein a number of the DMRS ports in the first group of DMRS ports is equal to a number of the PDSCH data layers in the first set of PDSCH data layers; and
the second group of DMRS ports is associated with a second CDM group different than the first CDM group, wherein a number of the DMRS ports in the second group of DMRS ports is equal to a number of the PDSCH data layers in the second set of PDSCH data layers.

5. The UE of claim 3, wherein the downlink reference signal includes a non-zero power (NZP) channel state information reference signal (CSI-RS) resource for channel measurement, and the NZP CSI-RS resource includes a first group of CSI-RS ports and a second group of CSI-RS ports.

6. The UE of claim 5, wherein the first group of DMRS ports is quasi-co-located with the first group of CSI-RS ports, and the second group of DMRS ports is quasi-co-located with the second group of CSI-RS ports.

7. The UE of claim 5, wherein the first group of DMRS ports is quasi-co-located with the first group of CSI-RS ports, and the second group of DMRS ports is quasi-co-located with the first group of CSI-RS ports and the second group of CSI-RS ports.

8. The UE of claim 3, wherein the downlink reference signal comprises a first non-zero power (NZP) channel state information reference signal (CSI-RS) resource and a second NZP CSI-RS resource for channel measurement.

9. The UE of claim 8, wherein the first group of DMRS ports is quasi-co-located with the first NZP CSI-RS resource, and the second group of DMRS ports is quasi-co-located with the first NZP CSI-RS resource and the second NZP CSI-RS resource.

10. The UE of claim 8, wherein the first NZP CSI-RS resource includes a first group of CSI-RS ports and a second group of CSI-RS ports, and wherein the first group of DMRS ports is quasi-co-located with the first group of CSI-RS ports, and the second group of DMRS ports is quasi-co-located with the second group of CSI-RS ports and the second NZP CSI-RS resource.

11. The UE of claim 1, wherein a number of layers in the first set of PDSCH data layers of the first TB is less than or equal to four layers, and a number of layers in the second set of PDSCH data layers of the second TB is less than or equal to two layers.

12. The UE of claim 1, wherein values of indices associated with the second set of PDSCH data layers are smaller than values of indices associated with the first set of PDSCH data layers.

13. The UE of claim 1, wherein the PDSCH configuration includes at least one of an indication that the UE is scheduled to receive the first codeword and the second codeword over the PDSCH, a resource allocation type parameter, a time-domain allocation type parameter, or a repetition scheme configuration.

14. The UE of claim 1, wherein the DCI includes an indication that the UE is scheduled to receive the first codeword corresponding to the first TB, and the second codeword corresponding to the second TB.

15. The UE of claim 14, wherein the indication is provided in at least one of a field of the DCI, or a subset of a field of the DCI.

16. The UE of claim 1, wherein the DCI has a DCI format indicating that the UE is scheduled to receive the two TBs associated with the different threshold TB error probabilities and wherein the first TB is associated with a first threshold TB error probability that is higher than a second threshold TB error probability associated with the second TB.

17. The UE of claim 1, wherein the first TB corresponds to a mobile broadband communication mode, and the second TB corresponds to at least one of a high reliability communication mode or a low latency communication mode.

18. (canceled)

19. A network entity (NE) for wireless communication, comprising:
at least one memory; and
at least one processor coupled with the at least one memory and operable to cause the NE to:
transmit a physical downlink shared channel (PDSCH) configuration;
transmit a downlink control information (DCI) for scheduling transmission of two transport blocks (TBs) to a user equipment (UE) over a PDSCH, the two TBs associated with different threshold transport block (TB) error probabilities; and
transmit over the PDSCH, according to the DCI and the PDSCH configuration, a first set of PDSCH data layers indicating a first codeword for a first TB of the two TBs and a second set of PDSCH data layers indicating a second codeword for a second TB of the two TBs.

20. A method performed by a user equipment (UE), comprising:
receiving a physical downlink shared channel (PDSCH) configuration;
receiving downlink control information (DCI) for scheduling communication of two transport blocks (TBs) to the UE over a PDSCH, the two TBs associated with different threshold transport block (TB) error probabilities; and
receiving over the PDSCH, based at least in part on the DCI and the PDSCH configuration, a first set of PDSCH data layers indicating a first codeword for a first TB of the two TBs and a second set of PDSCH data layers indicating a second codeword for a second TB of the two TBs.

21. A method performed by a network entity (NE), the method comprising:
transmitting a physical downlink shared channel (PDSCH) configuration;
transmitting downlink control information (DCI) for scheduling transmission of two transport blocks (TBs) to a user equipment (UE) over a PDSCH, the two TBs associated with different threshold transport block (TB) error probabilities; and
transmitting over the PDSCH, according to the DCI and the PDSCH configuration, a first set of PDSCH data layers indicating a first codeword for a first TB of the two TBs and a second set of PDSCH data layers indicating a second codeword for a second TB of the two TBs.
